(19) United States
(12) Patent Application Publication
(10) Pub. No.: US 2026/0059570 A1
(43) Pub. Date: Feb. 26, 2026

(54) METHOD AND APPARATUS FOR CHANNEL ACCESS IN WIRELESS LAN SYSTEM

(71) Applicant: Samsung Electronics Co., Ltd., Suwon-si (KR)

(72) Inventors: Seongho BYEON, Suwon-si (KR); Jonghoe KOO, Suwon-si (KR); Suhwook KIM, Suwon-si (KR); Mingyu LEE, Suwon-si (KR)

(21) Appl. No.: 19/306,335

(22) Filed: Aug. 21, 2025

(30) Foreign Application Priority Data
Aug. 21, 2024 (KR) 10-2024-0112391

(51) Int. Cl. H04W 74/0816; H04W 74/00; H04W 84/12

(52) U.S. Cl. CPC H04W 74/0816; H04W 74/002; H04W 84/12

(57) ABSTRACT

A method and an apparatus for channel access in a wireless LAN (WLAN) system are provided. In a wireless local area network (WLAN) system, the method performed by an access point (AP) includes identifying, by the AP, a first overlapping basic service set (OBSS) transmission opportunity (TXOP) including a primary channel; performing, by the AP, non-primary channel access (NPCA) based on identifying the first OBSS TXOP; identifying, by the AP, truncation of the first OBSS TXOP; and terminating, by the AP, the NPCA based on identifying the truncation of the first OBSS TXOP.

### CROSS-REFERENCE TO RELATED APPLICATION(S)

This application is based on and claims priority under 35 U.S.C. § 119 (a) of a Korean patent application number 10-2024-0112391, filed on Aug. 21, 2024, in the Korean Intellectual Property Office, the disclosure of which is incorporated by reference herein in its entirety.

### BACKGROUND

### 1. Field

The disclosure relates to a wireless local area network (WLAN) system. More particularly, the disclosure relates to a method and apparatus for channel access in a wireless LAN system.

### 2. Description of Related Art

A wireless local area network (WLAN) is also referred to as wireless fidelity (Wi-Fi) and is a network that enables Internet access within a predetermined distance with respect to a place, in which an access point (AP) is installed, using mobile terminals, laptops, or the like. WLAN technology has been continuously evolving in response to the growth of Internet usage and the expansion of the smartphone market. WLANs are used to provide high-speed data services throughout urban areas including schools, airports, hotels, and offices.

The Wi-Fi alliance defines Wi-Fi as a WLAN product based on the institute of electrical and electronics engineers (IEEE) 802.11 standard. IEEE 802.11a and 802.11b, published in 1997 and 1999 respectively, are standards that operate in unlicensed bands at 2.4 gigahertz (GHz) or 5 GHz. IEEE 802.11b provides a data rate of 11 megabits per second (Mbps), while IEEE 802.11a provides a data rate of 54 Mbps. In IEEE 802.11g, orthogonal frequency-division multiplexing (OFDM) is employed at 2.4 GHz, and a data rate of 54 Mbps is provided. IEEE 802.11n employs multiple-input multiple-output OFDM (MIMO-OFDM) and provides data rates of up to 300 Mbps using four spatial streams. IEEE 802.11n also supports channel bandwidths up to 40 MHz, and in this case, a data rate of 600 Mbps is provided.

Thereafter, the IEEE 802.11ac standard was introduced, which uses a maximum bandwidth of 160 MHz and supports up to eight spatial streams, thereby achieving data rates up to 1 gigabits per second (Gbps). Further, IEEE 802.11ax was introduced, providing multi-user MIMO (MU-MIMO) in both uplink and downlink, and supporting spatial frequency reuse and dynamic fragmentation. Thereafter, IEEE 802.11be is currently under development, targeting theoretical data rates of 46 Gbps by supporting a maximum of 320 ultra-wide channels, multi-link operation, and 4K quadrature amplitude modulation (QAM).

The above information is presented as background information only to assist with an understanding of the disclosure. No determination has been made, and no assertion is made, as to whether any of the above might be applicable as prior art with regard to the disclosure.

### SUMMARY

Aspect of the disclosure are to address at least the above-mentioned problems and/or disadvantages and to provide at least the advantages described below. Accordingly, an aspect of the disclosure is to provide a method and apparatus for channel access in a wireless LAN system.

Additional aspects will be set forth in part in the description which follows and, in part, will be apparent from the description, or may be learned by practice of the presented embodiments.

In accordance with an aspect of the disclosure, a method performed by an access point (AP) in a wireless local area network (WLAN) system is provided. The method includes identifying, by the AP, a first overlapping basic service set (OBSS) transmission opportunity (TXOP) including a primary channel, performing, by the AP, non-primary channel access (NPCA) based on identifying the first OBSS TXOP, identifying, by the AP, truncation of the first OBSS TXOP, and terminating, by the AP, the NPCA based on identifying the truncation of the first OBSS TXOP.

According to an embodiment of the disclosure, the method may further include identifying a second OBSS TXOP after the truncation of the first OBSS TXOP, and performing NPCA based on identifying the second OBSS TXOP.

According to an embodiment of the disclosure a trigger frame (TF) related to the NPCA comprises a user information field containing NPCA information, wherein the user information field comprises at least one of a BasicNAV information subfield indicating a BasicNAV value associated with a OBSS TXOP including the primary channel, or an NPCA duration subfield indicating a remaining NPCA duration, and wherein an association ID (AID) subfield of the user information field containing NPCA information has a predetermined value.

According to an embodiment of the disclosure, in case that an AP TXOP is initiated after the truncation of the first OBSS TXOP, the method may further include transmitting an initial control frame (ICF) for the AP TXOP in a primary channel and a secondary channel, receiving an initial control response (ICR) in the primary channel and the secondary channel from a first station (STA), having an operating bandwidth including the primary channel, and in case that the ICF schedules a second STA having an operating bandwidth including the primary channel, receiving the ICR in the secondary channel from the second STA.

According to an embodiment of the disclosure, in case that an AP TXOP is initiated after the truncation of the first OBSS TXOP, the method may further include transmitting a downlink (DL) multi-user (MU) physical layer protocol data unit (PPDU) in the primary channel and the secondary channel within the AP TXOP.

According to an embodiment of the disclosure, the method may further include transmitting an NPCA termination control (NTC) frame, wherein the NTC frame includes information indicating whether to maintain or terminate the NPCA for the second STA.

In accordance with another aspect of the disclosure, a method performed by a first station (STA) in a wireless local area network (LAN) system is provided. The method includes identifying, by the first STA, a first overlapping basic service set (OBSS) transmission opportunity (TXOP) including a primary channel, performing, by the first STA, non-primary channel access (NPCA) based on identifying the first OBSS TXOP, identifying, by the first STA, truncation of the first OBSS TXOP based on the first STA having an operating bandwidth including the primary channel, and terminating, by the first STA, the NPCA based on identifying the truncation of the first OBSS TXOP.

According to an embodiment of the disclosure, the method may further include identifying a second OBSS TXOP after the truncation of the first OBSS TXOP, and performing NPCA based on identifying the second OBSS TXOP.

According to an embodiment of the disclosure, in case that an AP TXOP is initiated after the truncation of the first OBSS TXOP, the method may further include receiving an initial control frame (ICF) for the AP TXOP in a primary channel and a secondary channel, and transmitting an initial control response (ICR) in the primary channel and the secondary channel.

In accordance with another aspect of the disclosure, a method performed by a second station (STA) in a wireless local area network (LAN) system is provided. The method includes performing, by the second STA, non-primary channel access (NPCA) triggered based on a first overlapping basic service set (OBSS) transmission opportunity (TXOP) including a primary channel, and continuing, by the second STA, the NPCA after truncation of the first OBSS TXOP based on the second STA having an operating bandwidth not including the primary channel.

According to an embodiment of the disclosure, the method may further include terminating the NPCA, based on receiving a downlink (DL) multi-user (MU) physical layer protocol data unit (PPDU) including the primary channel, terminating the NPCA.

According to an embodiment of the disclosure a trigger frame (TF) related to NPCA comprises a user information field containing NPCA information, wherein the user information field comprises at least one of a BasicNAV information subfield indicating a BasicNAV value associated with a OBSS TXOP including the primary channel, or an NPCA duration subfield indicating a remaining NPCA duration, and wherein an association ID (AID) subfield of the user information field containing NPCA information has a predetermined value.

According to an embodiment of the disclosure, the method may further include receiving the TF related to NPCA triggered by a second OBSS TXOP, in case that the second OBSS TXOP is initiated after the truncation of the first OBSS TXOP, configuring a BasicNAV value associated with the second OBSS TXOP based on the BasicNAV information subfield, and configuring a duration of the NPCA triggered by the second OBSS TXOP based on the NPCA duration subfield.

According to an embodiment of the disclosure, in case that an AP TXOP is initiated after the truncation of the first OBSS TXOP, the method may further include receiving an initial control frame (ICF) for the AP TXOP in a secondary channel, in case that the ICF schedules the second STA having an operating bandwidth not including the primary channel, transmitting an initial control response (ICR) in the secondary channel, and in case that the ICF does not schedule the second STA, starting an NPCA termination timer of the second STA.

According to an embodiment of the disclosure, in case that an AP TXOP is initiated after truncation of the first OBSS TXOP, the method may further include receiving an initial control frame (ICF) for the AP TXOP in a secondary channel in case that the ICF schedules the second STA having an operating bandwidth not including the primary channel, transmitting an initial control response (ICR) in the secondary channel, and in case that the ICF does not schedule the second STA, terminating the NPCA.

According to an embodiment of the disclosure, the method may further include, in case that the AP TXOP is initiated after the truncation of the first OBSS TXOP, receiving a downlink (DL) multi-user (MU) physical layer protocol data unit (PPDU) within the AP TXOP, wherein, in case that the DL MU PPDU includes a medium access control (MAC) protocol data unit (MPDU) for the second STA, an NPCA termination timer of the second STA is reset, and wherein, in case that the DL MU PPDU does not include the MPDU for the second STA, the NPCA termination timer of the second STA is started.

According to an embodiment of the disclosure, the method may further include receiving an NPCA termination control (NTC) frame in a secondary channel, wherein the NTC frame includes information indicating whether to maintain or terminate the NPCA by the second STA.

According to an embodiment of the disclosure, the method may further include, in case that the NTC frame indicates to maintain the NPCA by the second STA, the second STA continues the NPCA in the secondary channel, and wherein, in case that the NTC frame indicates to terminate the NPCA by the second STA, the second STA terminates the NPCA.

In accordance with another aspect of the disclosure, an access point (AP) in a wireless local area network (WLAN) system is provided. The AP includes a transceiver, memory, including one or more storage media, storing instructions, and one or more processors communicatively coupled to the transceiver and the memory, wherein the instructions, when executed by the one or more processors individually or collectively, cause the AP to identify a first overlapping basic service set (OBSS) transmission opportunity (TXOP) including a primary channel, perform non-primary channel access (NPCA) based on identifying the first OBSS TXOP, identify truncation of the first OBSS TXOP, and terminate the NPCA based on identifying the truncation of the first OBSS TXOP.

In accordance with another aspect of the disclosure, a first station (STA) in a wireless local area network (WLAN) system is provided. The first station includes a transceiver, memory, comprising one or more storage media, storing instructions, and one or more processors communicatively coupled to the transceiver and the memory, wherein the instructions, when executed by the one or more processors individually or collectively, cause the first STA to identify a first overlapping basic service set (OBSS) transmission opportunity (TXOP) including a primary channel, perform non-primary channel access (NPCA) based on identifying the first OBSS TXOP, identify truncation of the first OBSS TXOP based on the first STA having an operating bandwidth including the primary channel, and terminate the NPCA based on identifying the truncation of the first OBSS TXOP.

In accordance with another aspect of the disclosure, a second station (STA) in a wireless local area network (WLAN) system is provided. The second station includes a transceiver, memory, comprising one or more storage media, storing instructions, and one or more processors communicatively coupled to the transceiver and the memory, wherein the instructions, when executed by the one or more processors individually or collectively, cause the first STA to identify a first overlapping basic service set (OBSS) transmission opportunity (TXOP) including a primary channel, perform non-primary channel access (NPCA) based on identifying the first OBSS TXOP, identify truncation of the first OBSS TXOP based on the first STA having an operating bandwidth including the primary channel, and terminate the NPCA based on identifying the truncation of the first OBSS TXOP.

In accordance with another aspect of the disclosure, one or more non-transitory computer-readable storage media storing one or more computer programs including computer-executable instructions that, when executed by one or more processors of an access point (AP) individually or collectively, cause the AP to perform operations are provided. The operations include identifying, by the AP, a first overlapping basic service set (OBSS) transmission opportunity (TXOP) including a primary channel, performing, by the AP, non-primary channel access (NPCA) based on identifying the first OBSS TXOP, identifying, by the AP, truncation of the first OBSS TXOP, and terminating, by the AP, the NPCA based on identifying the truncation of the first OBSS TXOP.

Various embodiments of the disclosure provide a method and apparatus for channel access in a wireless LAN system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a wireless communication network according to an embodiment of the disclosure;

FIG. 2 illustrates an example structure of an electronic device that performs WLAN access, according to an embodiment of the disclosure;

FIG. 3 illustrates an example of a link setup process in a typical wireless LAN, according to an embodiment of the disclosure;

FIG. 4 illustrates an example of a hidden node and an exposed node and an example of request to send (RTS) and clear to send (CTS) for addressing problems associated with the hidden and exposed nodes, according to an embodiment of the disclosure;

FIG. 5 illustrates an example of a frame structure used in an IEEE 802.11 system, according to an embodiment of the disclosure;

FIG. 6 illustrates an example of NAV configuration according to an embodiment of the disclosure;

FIG. 7 illustrates an example of a TXOP according to an embodiment of the disclosure;

FIG. 8A illustrates an example of a channel access according to an embodiment of the disclosure;

FIG. 8B illustrates an example of a channel access according to an embodiment of the disclosure;

FIG. 9 illustrates an example of TXOP truncation according to an embodiment of the disclosure;

FIG. 10 illustrates an example of operations of an NPCA AP and/or NPCA STA when a second OBSS TXOP is initiated after truncation of a first OBSS TXOP, according to an embodiment of the disclosure;

FIG. 11 illustrates an example of a trigger frame (TF) according to an embodiment of the disclosure;

FIG. 12 illustrates an example of a user information field in a trigger frame for transmitting NPCA information, according to an embodiment of the disclosure;

FIG. 13A illustrates an example of operations of an NPCA AP when an NPCA AP TXOP is initiated after truncation of a first OBSS TXOP, according to an embodiment of the disclosure;

FIG. 13B illustrates an example of operations of an NPCA STA when an NPCA AP TXOP is initiated after truncation of a first OBSS TXOP, according to an embodiment of the disclosure;

FIG. 13C illustrates another example of operations of an NPCA STA when an NPCA AP TXOP is initiated after truncation of a first OBSS TXOP, according to an embodiment of the disclosure;

FIG. 13D illustrates yet another example of operations of an NPCA STA when an NPCA AP TXOP is initiated after truncation of a first OBSS TXOP, according to an embodiment of the disclosure;

FIG. 14 illustrates an example of operations of an NPCA AP and/or NPCA STA based on an NPCA termination control (NTC) frame, according to an embodiment of the disclosure;

FIG. 15 illustrates an example of a method performed by an access point (AP), according to an embodiment of the disclosure;

FIG. 16 illustrates an example of a method performed by a first station (STA), according to an embodiment of the disclosure; and

FIG. 17 illustrates an example of a method performed by a second station (STA), according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

Embodiments are described below in association with wireless LAN systems merely for the sake of simplicity. However, it should be understood that the embodiments are also applicable to other wireless networks (e.g., cellular networks, pico networks, femto networks, satellite networks), as well as to systems using signals of one or more wired standards or protocols (e.g., Ethernet and/or HomePlug or power line communication (PLC) standards). As used herein, the terms WLAN and Wi-Fi® may include communications governed by the IEEE 802.11 family of standards, BLUETOOTH®, high performance radio local area network (HiperLAN) (a set of wireless standards primarily used in Europe and comparable to IEEE 802.11 standards), and other technologies having relatively short wireless transmission ranges. Accordingly, the terms WLAN and Wi-Fi may be used interchangeably throughout this specification. Additionally, although an infrastructure WLAN system including one or more APs and a plurality of wireless stations (STAs) is described below, the embodiments are equally applicable to other WLAN systems, including, for example, multiple WLANs, peer-to-peer (or independent basic service set) systems, Wi-Fi direct systems, and/or hotspots.

Furthermore, although the specification describes the exchange of data frames between wireless devices, the embodiments may be applied to the exchange of any data unit, packet, and/or frame between wireless devices. Therefore, the term “frame” may include any frame, packet, or data unit such as protocol data units (PDUs), medium access control (MAC) protocol data units (MPDUs), and physical layer convergence procedure (PLCP) protocol data units (PPDUs). The term A-MPDU may refer to aggregated MPDUs. In the following description, the term (A-)MPDU may be understood as encompassing both MPDUs and A-MPDUs. In the following description, a wireless LAN or WLAN network may implement at least one of the IEEE 802.11 wireless communication protocol standards, such as those defined in IEEE 802.11-2016 standards or its amendments (including but not limited to 802.11ah, 802.11ad, 802.11ay, 802.11ax, 802.11az, 802.11ba, and 802.11be).

For a thorough understanding of the disclosure, numerous specific details such as examples of specific components, circuits, and processes are set forth in the following description. The term “connected”, as used herein, refers to being directly connected or connected via one or more intervening components or circuits. The term “accessed AP” refers to an access point to which a given wireless station is currently associated and/or connected (e.g., a communication channel or link is established between the access point and the given wireless station). Furthermore, in the following description, specific terminology is provided for the purpose of explanation and to facilitate a thorough understanding of the embodiments. However, it will be apparent to those skilled in the art that such specific details may not be necessary to practice the embodiments. In other instances, well-known circuits and devices are shown in block diagram form to avoid obscuring the essence of the disclosure.

Hereinafter, the operation principle of the disclosure will be described in detail in conjunction with the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

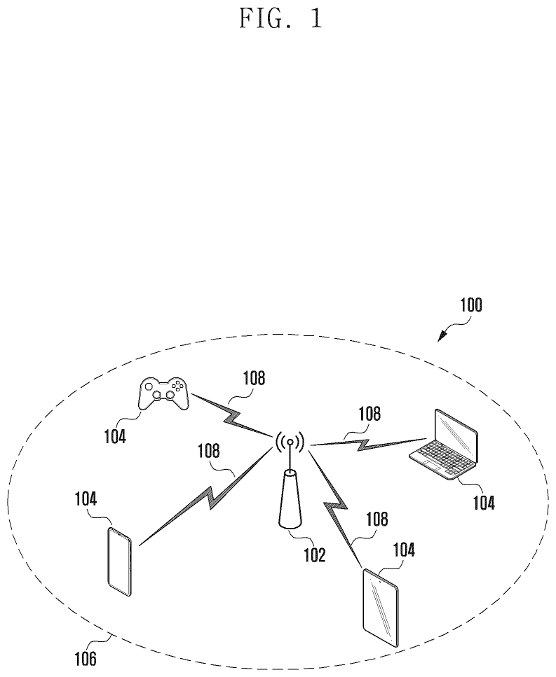

FIG. 1 illustrates an example of a wireless communication network according to an embodiment of the disclosure.

A wireless communication network 100 may be an example of a wireless LAN, such as a Wi-Fi network. The wireless communication network 100 may include a plurality of wireless communication devices, such as an access point (AP) 102 and a plurality of stations (STAs) 104. Although only one AP 102 is illustrated, the wireless communication network 100 may include multiple APs 102.

An STA is a logical entity that includes a MAC and a physical (PHY) layer interface for a wireless medium, and includes an AP and a non-AP STA. Among STAs, a portable terminal operated by a user is a non-AP STA, and the term “STA” also refers to a non-AP STA when simply used without distinction. Hereinafter, the term “STA” may refer to a non-AP STA. Each of the STAs 104 may also be referred to as a terminal or a device. As used herein, the term “terminal” or “device” may also be referred to as a mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Various examples of the terminal may include a cellular phone, a smartphone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storage and playback home appliance having a wireless communication function, an Internet hole appliance capable of wireless Internet access and browsing, and portable units or terminals having integrated combinations of these functions. Furthermore, the terminal may include a machine to machine (M2M) terminal and a machine type communication (MTC) terminal/device, but is not limited thereto. As used herein, the terminal may also be referred to as an electronic device or simply as a device.

The AP 102 is an entity that provides access to a distribution system (DS) via a wireless medium for an associated station (STA) coupled to the AP. The AP may also be referred to as a central controller, base station (BS), Node B, base transceiver system (BTS), or site controller.

A coverage area 106 of the AP 102 capable of representing a basic service area (BSA) of the wireless communication network 100 is illustrated. The AP 102 periodically broadcasts beacon frames (which may be interchangeably referred to as beacons) including a basic service set identifier (BSSID), in order to enable random STAs 104 within a wireless range of the AP 102 to associate or reassociate with the AP 102, establish individual communication links 108 (also referred to as Wi-Fi links) with the AP 102, or maintain the communication links 108 with the AP 102. The AP 102 may provide access to external networks for various STAs 104 within the WLAN via the individual communication links 108.

A single AP 102 and a set of associated STAs 104 may be referred to as a basic service set (BSS), which is managed by the AP 102. A BSS may be identified by users through a service set identifier (SSID) and may be identified by other devices through a BSSID, which may be the MAC address of the AP 102.

The BSS may be classified as an infrastructure BSS and an independent BSS (IBSS). The BSS illustrated in FIG. 1 is an IBSS, and an infrastructure BSS (not shown) may also be established. An infrastructure BSS includes one or more STAs and an AP. In an infrastructure BSS, communication between non-AP STAs is generally performed via the AP. However, when a direct link is established between non-AP STAs, direct communication between them is also possible.

A plurality of infrastructure BSSs may be interconnected via a DS. Multiple BSSs connected through a DS are referred to as an extended service set (ESS). STAs included in the ESS may communicate with one another and may move from one BSS to another BSS within the same ESS while maintaining communication seamlessly.

The DS is a mechanism that connects multiple APs. It does not necessarily have to be a network, and its form is unrestricted as long as it can provide a predetermined distribution service. For example, the DS may be a wireless network such as a mesh network or may be a physical structure interconnecting the APs.

In addition, the AP 102 and the STA 104 may be referred to as an access point multi-link device (AP-MLD) and STA-MLD, respectively. This indicates that the AP and STA may support multi-link operation.

The following describes an example of a hierarchical structure according to the IEEE 802.11 standard documentation.

The IEEE 802.11 standard document defines the development of MAC and PHY protocols corresponding to Wi-Fi wireless access technology. A data link layer (DLL) includes a MAC sublayer, which is responsible for medium access control. The MAC sublayer receives packets from a higher layer, such as 802.1X Port Filtering, through a MAC_SAP interface, constructs IEEE 802.11 MAC frames from the packets, and delivers the frames to the physical layer. The physical layer includes a physical layer convergence procedure (PLCP) sublayer and a physical medium dependent (PMD) sublayer. The PLCP sublayer serves to construct a PLCP frame from the IEEE 802.11 MAC frames constructed by the MAC sublayer. The PLCP frames are then transmitted to a peer terminal through the PMD sublayer.

Various management frames used to manage Wi-Fi wireless access are not delivered from the 802.1X higher layer. These management frames are transmitted in the form of requests and responses between station management entities (SMEs) located within each terminal. The SME is a layer-independent entity that may exist in a separate management plane or appear to be off to the side. For example, when an AP wants to establish a BSS, the AP instructs beacon transmission through MLME_SAP interfaces, such as MLME-START.request and MLME-START.confirm primitives. When a STA wants to associate with the AP, the STA instructs the transmission of association request/response frames using MLME-ASSOCIATE.request, MLME-ASSOCIATE.response, MLME-ASSOCIATE.confirm, and MLME-ASSOCIATE.indication primitives. Meanwhile, if the SME wants to configure operating parameter values related to the physical layer, the SME may configure various physical parameter values through a PLCP_SAP interface.

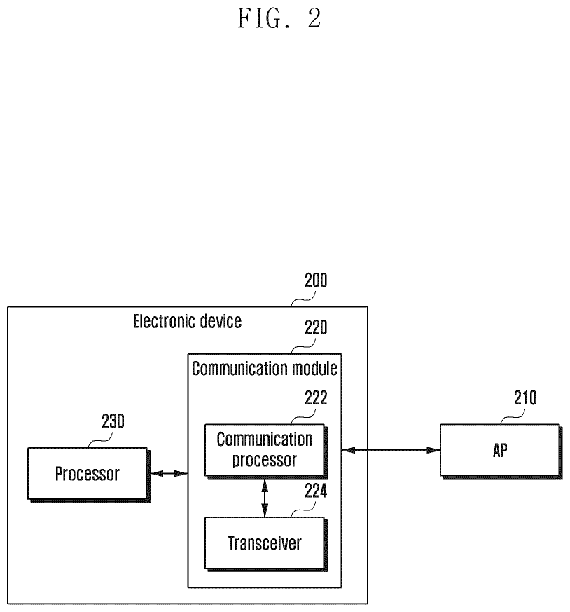

FIG. 2 illustrates an example structure of an electronic device that performs WLAN access according to an embodiment of the disclosure.

Referring to FIG. 2, an electronic device 200 may be connected to an AP 210, and the electronic device 200 may include a processor 230 and a communication module 220. The electronic device 200 may correspond to the STA 104 of FIG. 1 and, in this case, the electronic device 200 may be connected to the AP 210 as illustrated. Alternatively, the electronic device 200 may correspond to the AP 102 of FIG. 1 and, in that case, the electronic device may be connected to the STA 104 and/or another AP, as shown in FIG. 1.

The communication module 220 may receive a communication signal from the outside or transmit a communication signal to the outside, based on a Wi-Fi communication scheme (e.g., IEEE Std 802.11™). For example, the communication module 220 may operate based on IEEE 802.11ac, 802.11ax, 802.11be, or 802.11bn among Wi-Fi communication schemes, and in particular, IEEE 802.11be or 802.11bn has improved performance compared to IEEE 802.11ax by supporting a wider bandwidth, higher data throughput, and low latency.

The communication module 220 may include a transceiver 224 and a communication processor 222 (e.g., a communication processor (not shown) or a short-range wireless communication module (e.g., a Wi-Fi chipset) for data transmission and reception to and from external devices. According to various embodiments, the communication module 220 may further include memory.

According to various embodiments, the transceiver 224 may convert a baseband transmit signal into a wireless signal or convert a received wireless signal into a baseband reception signal.

According to various embodiments, the communication module 220 may further include elements for orthogonal frequency-division multiplexing (OFDM) or orthogonal frequency-division multiple access (OFDMA), such as a modulator, a digital-to-analog converter (DAC), a frequency converter, analog to digital (A/D) converter, an amplifier, and/or a demodulator, in addition to the transceiver 224 and the communication processor 222.

Although not shown, according to various embodiments, the electronic device 200 may include at least one antenna module that is electrically connected to the communication module of the AP 210 and supports the communication protocols and/or frequency bands supported by the communication module of the AP 210.

The communication processor 222 may control the transceiver 224 to establish a communication connection with the AP 210. For example, the communication connection may include a Wi-Fi network. The communication processor 222 may control the transceiver 224 to establish a wireless connection with the AP 210 by using WLAN standards operating in the 2.4 GHZ, 5 GHZ, or 6 GHz bands, such as IEEE 802.11ac, 802.11ax, 802.11be, or 802.11bn. Alternatively, the communication processor 222 may control the transceiver 224 to establish a wireless connection with the AP 210 by using a WLAN standard in the 60 GHz band, such as IEEE 802.11ad or 802.11ay. In addition, the communication scheme between the electronic device 200 and the AP 210 using a WLAN standard may be referred to as a communication method based on an STA mode.

According to various embodiments, the processor 230 may include an application processor. The processor 230 may perform designated operations of the electronic device 200 or control other hardware (e.g., the communication module 220) to perform designated operations. The processor 230 may control the electronic device 200 to perform operations according to various embodiments of the disclosure. For example, when the electronic device 200 is an STA, the processor 230 may control the STA to perform STA operations according to various embodiments of the disclosure. When the electronic device 200 is an AP, the processor 230 may control the AP to perform AP operations according to various embodiments of the disclosure.

According to various embodiments, the AP 210 may, based on connections between the external network and multiple electronic devices (e.g., electronic device 200), support transmitting packets to an external network (e.g., the Internet, an external LAN, or a cellular network) and/or receiving packets by the multiple electronic devices from the external network.

In an example, the AP 210 may be a wireless router. The AP 210 may be a dedicated wireless router or a general-purpose device supporting a mobile hotspot function, and is not limited in its implementation. For instance, the AP 210 may include the same elements (e.g., a processor and/or a communication module) as those of the electronic device 200. The AP 210 may also transmit and receive data to and from an external device such as a server. For example, the AP 210 may transmit at least a portion of data received from a server to the electronic device 200.

When the electronic device 200 corresponds to the AP 102 in FIG. 1, the electronic device 200 may include, although not illustrated, a separate communication module for connection to an external network. The communication module may be controlled by the processor 230 or by a separate processor. The separate communication module may include a transceiver and processor, and optionally memory. The electronic device 200 may also include a separate antenna module or a wired connection device for connection to an external network.

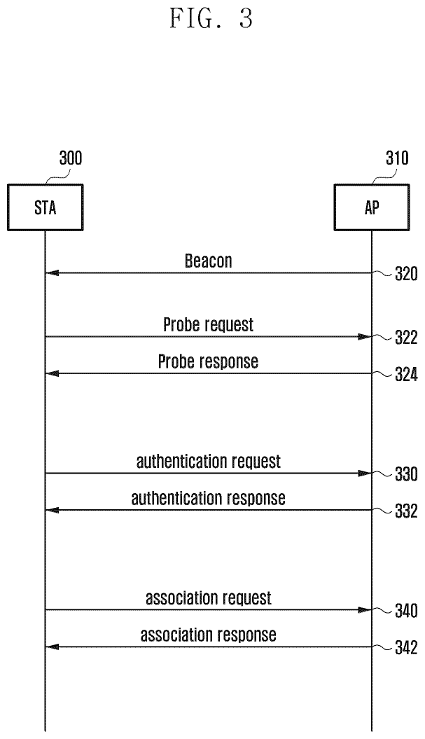

FIG. 3 illustrates an example of a typical link setup process of a wireless LAN according to an embodiment of the disclosure.

In order for an STA to set up a link with respect to a network and transmit or receive data to and from the network, the STA should first discover the network, perform authentication, establish an association, and carry out an authentication procedure for security. The link setup process may also be referred to as a session initiation or session setup process. The procedures of discovery, authentication, association, and security configuration in the link setup process may collectively be referred to as an association process.

Referring to FIG. 3, an STA 300 may perform a network discovery operation. The network discovery operation may include a scanning operation of the STA 300. That is, in order for the STA 300 to access a network, the STA should discover an available network. Before participating in a wireless network, the STA 300 should identify a compatible network. This process of identifying networks existing in a specific area is referred to as scanning.

Scanning may be classified into active scanning and passive scanning. In active scanning, the STA 300 that performs scanning transmits a probe request frame 322 while switching channels to search for nearby APs and waits for a response thereto. In response to the probe request frame, a responder transmits a probe response frame 324 to the STA that has transmitted the probe request frame. The responder may be an AP or STA that last transmitted a beacon frame on the channel being scanned in a BSS. FIG. 3 illustrates an example of a BSS in which an AP 310 transmits a beacon frame 320, thereby serving as a responder. In an IBSS, beacon frames are transmitted in turn by the STAs within the IBSS, and thus the responder is not fixed. For example, when an STA transmits a probe request frame on channel 1 and receives a probe response frame on channel 1, the STA may store BSS-related information from the received probe response frame and then move to the next channel to perform scanning in the same manner.

The scanning operation may also be performed in a passive scanning manner. In passive scanning, an STA performing scanning detects beacon frames while switching channels. A beacon frame is one of the management frames defined in IEEE 802.11, and is periodically transmitted to announce the presence of a wireless network and to allow an STA performing scanning to discover and participate in the wireless network. In FIG. 3, an example of a BSS is illustrated in which the AP 310 periodically transmits beacon frames 320 to the STA 300. In an IBSS, beacon frames are transmitted in turn by the STAs in the IBSS. Upon receiving a beacon frame, an STA performing scanning stores information regarding the BSS included in the beacon frame and moves to other channels to record beacon information on each channel. Compared to passive scanning, active scanning may provide advantages such as lower delay and reduced power consumption.

After discovering a network, the STA 300 may perform an authentication process. This authentication process may be referred to as the first authentication process to clearly distinguish this from a security setup operation described later. The authentication process includes a process in which the STA 300 transmits an authentication request frame 330 to the AP 310, and in response thereto, the AP 310 transmits an authentication response frame 332 to the STA 300. The authentication frame used for the authentication request/response corresponds to a management frame.

Authentication frames may include information such as an authentication algorithm number, an authentication transaction sequence number, a status code, challenge text, a robust security network (RSN), and a finite cyclic group. These are merely examples of information that may be included in authentication request/response frames and may be replaced with other types of information or include additional information.

The AP 310 may determine whether to allow authentication of the STA, based on the information included in the received authentication request frame. The AP 310 may provide the result of authentication process to the STA 300 through the authentication response frame.

After the STA has been successfully authenticated, an association process may be performed. The association process includes a process in which the STA 300 transmits an association request frame 340 to the AP 310, and in response thereto, the AP 310 transmits an association response frame 342 to the STA 300.

In an example, the association request frame may include information regarding various capabilities, a beacon listen interval, an SSID, supported rates, supported channels, a robust security network (RSN), a mobility domain, supported operating classes, a traffic indication map (TIM) broadcast request, interworking service capabilities, and the like.

In an example, the association response frame may include information regarding various capabilities, a status code, an association ID (AID), supported rates, an enhanced distributed channel access (EDCA) parameter set, a received channel power indicator (RCPI), a received signal-to-noise indicator (RSNI), a mobility domain, a timeout interval (e.g., association comeback time), overlapping BSS scan parameters, TIM broadcast response, quality of service (QoS) mapping, and the like.

These are merely examples of information that may be included in association request/response frames and may be replaced with other types of information or include additional information.

Although not illustrated, after the STA has successfully associated with the network, a security setup process may be performed. The security setup process may be referred to as an authentication process performed through robust security network association (RSNA) request/response. The authentication process may be referred to as a first authentication process, and the security setup process may also be referred to as an authentication process.

The security setup process may include a private key setup procedure via, for example, a 4-way handshake using extensible authentication protocol over LAN (EAPOL) frames, or it may be performed using a security method not defined in the IEEE 802.11 standard.

The following describes a medium access control (MAC) protocol provided by IEEE 802.11.

In a wireless LAN system based on IEEE 802.11, the basic access mechanism of the MAC is based on the distributed coordination function (DCF), which uses carrier sense multiple access with collision avoidance (CSMA/CA). Carrier sensing method in the DCF includes physical carrier sensing and virtual carrier sensing methods. The physical carrier sensing method involves sensing the channel status at the physical layer and notifying the MAC layer of the result thereof. The virtual carrier sensing method involves reserving a channel in advance by broadcasting a channel occupancy time to surrounding stations. An STA or AP that has secured a transmission channel records the channel occupancy time in an RTS frame and/or a CTS frame, or a data frame, and transmits the frames. Other STAs that has received the frames determine that the channel is in use during this channel occupancy time and refrain from contending for the channel, thereby avoiding collisions.

The physical carrier sensing method is fundamentally based on a “listen before talk” access mechanism. According to this type of access mechanism, an AP and/or STA may perform a clear channel assessment (CCA) to sense a wireless channel, a carrier, or medium for a predetermined time duration before initiating transmission. This predetermined time duration is referred to as an inter-frame space (IFS), and may differ depending on the priority of the traffic to be transmitted. That is, the priority may be determined based on the length of the time duration, and the higher the priority of a packet, the shorter the time duration may be.

The IFS may include a short IFS (SIFS), a priority IFS (PIFS), a distributed (coordinated function) IFS (DIFS), an arbitration IFS (AIFS), and the like. The SIFS represents the shortest time duration and may be primarily used as a waiting time for control information. The PIFS represents a medium-length time duration and may correspond to packets with medium priority (PIFS=SIFS+1 slot time). In comparison to the SIFS and PIFS, the DIFS represents the longest time duration, has the lowest priority, and may be used as a waiting time to identify channel availability (DIFS=SIFS+2 slot time). That is, for example, an STA intending to perform transmission may listen to (or sense) a channel during the DIFS period to identify whether the channel is in use.

When, as a result of the sensing, the medium is determined to be in an idle state, the AP and/or STA starts frame transmission through the medium. On the other hand, if the medium is sensed to be in an occupied state, the AP and/or STA does not initiate its own transmission, but may configure a delay period for medium access (e.g., a random backoff period) and wait for the period before attempting to transmit the frame. By applying the random backoff period, multiple STAs are expected to attempt frame transmission after waiting for different durations, thereby minimizing collisions.

However, this DCF scheme does not consider the priority among STAs, and thus has difficulty in supporting various types of data transmission and quality of service (QoS). Accordingly, a hybrid coordination function (HCF) was introduced. The HCF is based on the DCF and a point coordination function (PCF). The PCF is a polling-based synchronous access scheme, in which polling is periodically performed so that all receiving STAs and/or APs can receive data frames. The HCF includes enhanced distributed channel access (EDCA), which is a contention-based channel access method, and HCF controlled channel access (HCCA), which is a contention-free access method based on a polling mechanism. In addition, the HCF includes a medium access mechanism for improving the QoS of a WLAN, and can transmit QoS data during both the contention period (CP) and the contention-free period (CFP).

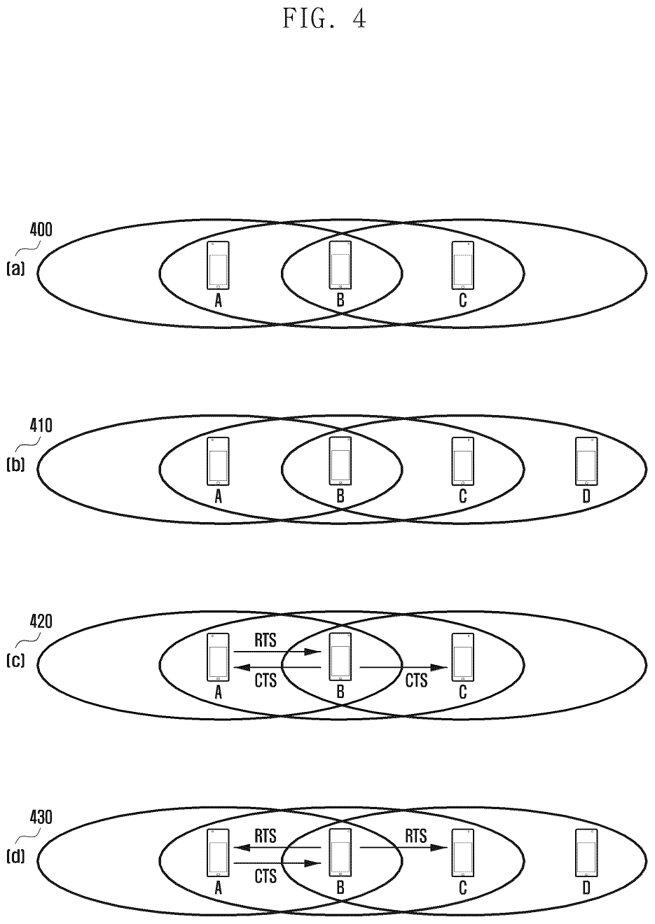

FIG. 4 illustrates an example of a hidden node and an exposed node and an example of RTS and CTS for addressing problems associated with the hidden and exposed nodes, according to an embodiment of the disclosure.

Referring to FIG. 4, part (a) (indicated by reference numeral 400) illustrates an example of a hidden node. When STA A and STA B are communicating and STA C has information to transmit, STA C may determine that the medium is in an idle state when STA C performs carrier sensing prior to transmitting data to STA B, even though STA A is transmitting information to STA B. This may occur because the transmission by STA A (i.e., medium occupation) is not sensed at the location of STA C. In such a case, a collision may occur because STA B receives data simultaneously from both STA A and STA C. In this case, STA A is referred to as a hidden node with respect to STA C.

Part (b) (indicated by reference numeral 410) illustrates an example of an exposed node. In a situation where STA B is transmitting data to STA A, STA C may have information to transmit to STA D. In this case, when STA C performs carrier sensing, it may determine that the medium is occupied due to the transmission of STA B. Accordingly, even if STA C has information to transmit to STA D, STA C should wait until the medium is to be in an idle state. However, in reality, since STA A is outside the transmission range of STA C, the transmissions from STA C and STA B may not collide from the perspective of STA A, and thus STA C unnecessarily waits for STA B to stop transmitting. In this case, STA C may be referred to as an exposed node with respect to STA B.

To efficiently utilize a collision avoidance mechanism in the situation described above, short signaling packets such as request to send (RTS) and clear to send (CTS) may be used. An STA that intends to transmit data sends the RTS to an STA that is to receive data, and a recipient STA that has received the RTS responds to the transmitting STA by using a CTS frame. The RTS and/or CTS exchanged between the two STAs may be overheard by surrounding STAs, thereby enabling the surrounding STAs to consider whether information transmission is occurring between the two STAs.

Part (c) (indicated by reference numeral 420) illustrates an example of a method for solving the hidden node problem. Assume that both STA A and STA C intend to transmit data to STA B. When STA A transmits an RTS to STA B, STA B transmits a CTS to STA A. STA C, which overhears both the RTS and CTS, defers its own medium access until the data transmission between STA A and STA B is completed, thereby avoiding a collision.

Part (d) (indicated by reference numeral 430) illustrates an example of a method for solving the exposed node problem. STA B, which intends to transmit data to STA A, may transmit an RTS, and STA A, which is to receive the data, may respond to the RTS by transmitting a CTS. When STA C receives only the RTS transmitted by STA B but fails to receive the CTS transmitted by STA A, STA C may know that STA A is outside of the carrier sensing range of STC C. In this case, STA C may determine that transmitting data to another STA (e.g., STA D) would not cause a collision, and may proceed with the data transmission.

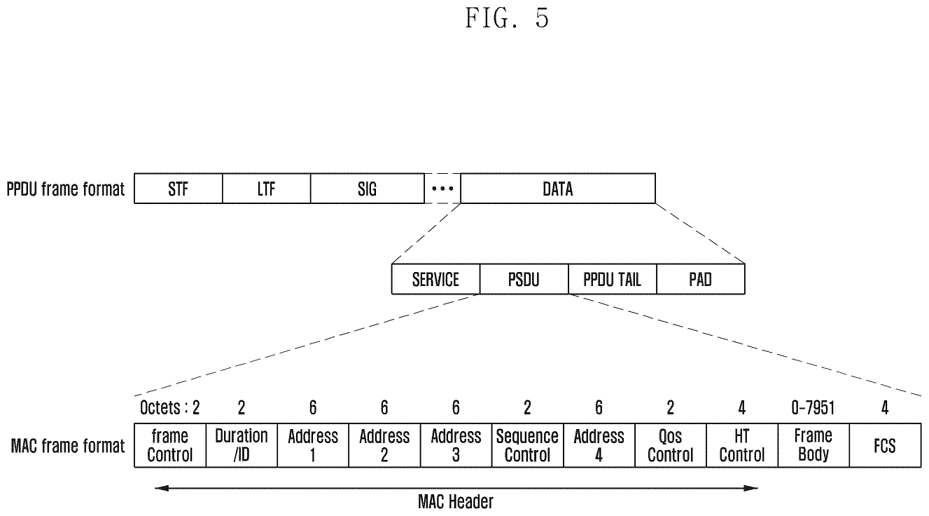

FIG. 5 illustrates an example of a frame structure used in an IEEE 802.11 system according to an embodiment of the disclosure.

A physical layer protocol data unit (PPDU) format may include a short training field (STF), a long training field (LTF), a SIGNAL (SIG) field, and a data field. A basic (e.g., non-high throughput (non-HT)) PPDU frame format may include only a legacy-STF (L-STF), a legacy-LTF (L-LTF), a SIG field, and a data field.

The STF may be used for frame timing acquisition, automatic gain control (AGC), diversity detection, and coarse frequency/time synchronization. The LTF may be used for fine frequency/time synchronization and channel estimation. The STF and LTF together may be referred to as a PLCP preamble, and the PLCP preamble may be called a signal for synchronization and channel estimation of an OFDM physical layer.

The SIG field may be used to transmit control information for demodulating and decoding the data field. The SIG field may include information on the data rate and data length. Additionally, the SIG field may include parity bits, SIG TAIL bits, and the like.

The data field may include a SERVICE field, a physical layer service data unit (PSDU), and PPDU TAIL bits, and may further include padding bits if necessary. Some bits of the SERVICE field may be used for descrambling at a receiving node. The PSDU corresponds to a MAC protocol data unit (MPDU) defined at the MAC layer and may contain data generated or used by a higher layer. The PPDU TAIL bits may be used to return an encoder to a zero state. The padding bits may be used to align the data field length to a predetermined unit.

An MPDU is defined according to various MAC frame formats, and a basic MAC frame is configured by a MAC header, a frame body, and a frame check sequence (FCS). The MAC frame is configured by an MPDU, and may be transmitted/received through a PSDU of a data part of a PPDU format.

The MAC header is defined as a region including a frame control field, a duration/ID field, address 1 field, address 2 field, address 3 field, a sequence control field, address 4 field, a QoS control field, and an HT control field.

The frame control field contains information indicating characteristics of the MAC frame. The duration/ID field may be implemented to have different values depending on the type and subtype of the corresponding MAC frame.

The address 1 to address 4 fields are used to indicate the BSSID, source address (SA), destination address (DA), transmitting address (TA) indicating a transmitting STA address, and receiving address (RA) indicating a recipient STA address.

The sequence control field is configured to include a sequence number and a fragment number. The sequence number may indicate the sequence number assigned to the MAC frame, while the fragment number may indicate the number of each fragment of the MAC frame.

The QoS control field contains information related to quality of service (QoS). The QoS control field may be included when the subtype subfield indicates a QoS data frame. The HT control field contains control information related to HT and/or VHT transmission/reception schemes.

The frame body is defined as the MAC payload, includes data to be transmitted by the higher layer, and has a variable size. For example, the maximum MPDU size may be 11,454 octets, and the maximum PPDU size may be 5.484 ms.

The FCS is defined as the MAC footer and is used for error detection of the MAC frame.

The first three fields (frame control field, duration/ID field, and address 1 field) and the last field (FCS field) constitute a minimum frame format and exist in all frames. The other fields may only exist in specific frame types.

The following describes a network allocation vector (NAV) used in wireless LAN networks.

As described above, the CSMA/CA mechanism includes not only physical carrier sensing, in which an AP and/or STA directly senses the medium, but also virtual carrier sensing. Virtual carrier sensing is intended to compensate for issues that may arise in medium access, such as the hidden node problem. To implement virtual carrier sensing, the MAC of a wireless LAN system may use the NAV. The NAV is a value configured by an AP and/or STA that is currently using the medium or has the right to use the medium, indicates, to other APs and/or STAs, the remaining time until the medium becomes available. Accordingly, the value configured by the NAV corresponds to a period during which the AP and/or STA transmitting the frame is scheduled to use the medium, and an STA that receives the NAV is prohibited from accessing the medium during the corresponding period. The NAV may be configured, for example, based on a value of the duration field of the MAC header of a frame.

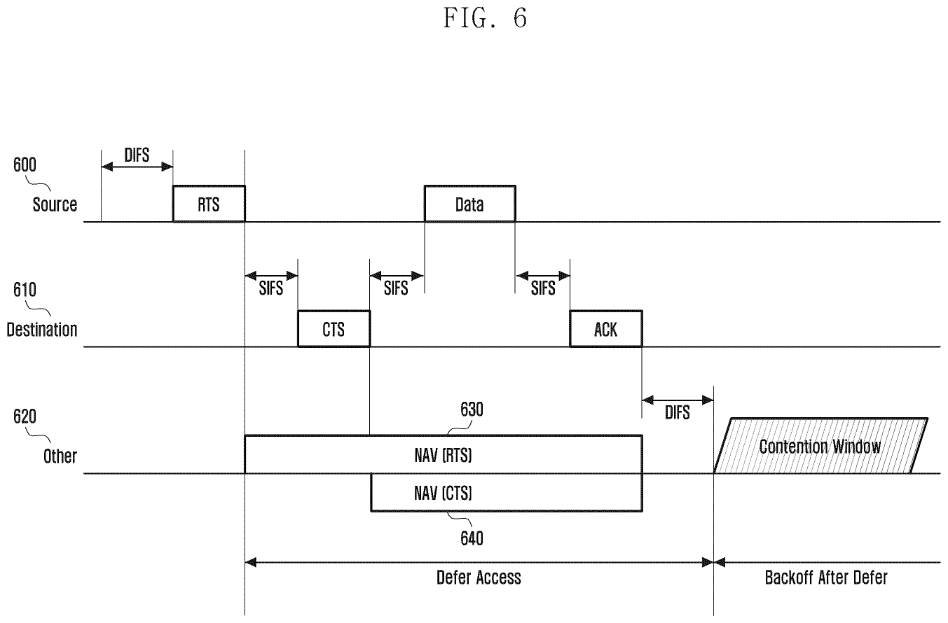

FIG. 6 illustrates an example of NAV configuration according to an embodiment of the disclosure.

Referring to FIG. 6, a source STA 600 transmits an RTS frame after a DIFS, and a destination STA 610 transmits a CTS frame after a SIFS. The destination STA, which is designated as a receiver through the RTS frame, does not configure an NAV. Some of the remaining STAs 620 may receive the RTS frame to configure an NAV 630, and the others may receive the CTS frame to configure an NAV 640.

When a CTS frame (e.g., a PHY-RXSTART.indication primitive) is not received within a predetermined period from a timepoint at which the RTS frame is received (e.g., a timepoint at which the MAC receives a PHY-RXEND.indication primitive corresponding to the RTS frame), STAs that have configured or updated their NAVs through the RTS frame may reset their NAVs (e.g., to zero). The predetermined period may be defined as (2*aSIFSTime+CTS Time+aRxPHYStartDelay+2*aSlotTime). CTS_Time may be calculated based on the length and data rate of the CTS frame indicated by the RTS frame. This predetermined period may be referred to as an NAVTimeout period.

Although FIG. 6 illustrates, for convenience, an example in which the NAV is configured or updated through an RTS or CTS frame, the NAV may also be configured/reconfigured/updated based on the duration field of various other types of frames, such as the duration field of a non-HT PPDU, HT PPDU, VHT PPDU, or HE PPDU (for example, the duration field in the MAC header of a MAC frame).

In addition, IEEE 802.11ax introduces a basic NAV and an intra-BSS NAV. The basic NAV is always configured (mandatory) based on frames transmitted by an AP or STA other than the device itself, whereas the intra-BSS NAV is optionally configured based on frames transmitted by the BSS to which the device belongs. The AP or STA may access the medium only when both NAV timers have expired (i.e., after all NAV time durations have elapsed).

The following describes a transmission opportunity (TXOP). TXOP was newly introduced in the IEEE 802.11e MAC to ensure quality of service (QoS) and improve channel utilization. To guarantee QoS, TXOP allows transmission opportunities to be allocated such that two or more packets belonging to the same access category (AC) can be transmitted preferentially.

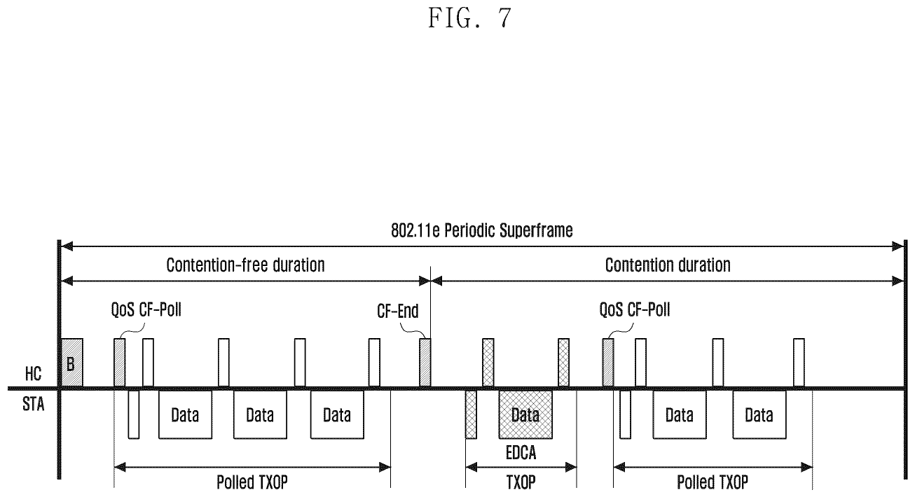

FIG. 7 illustrates an example of a TXOP according to an embodiment of the disclosure.

An STA participating in QoS transmission may obtain a TXOP to transmit traffic for a designated period using two channel access methods including EDCA and HCCA. A TXOP may be obtained by winning EDCA contention or by receiving a QoS contention-free poll (CF-poll) frame from the AP. The former is referred to as an EDCA TXOP, and the latter is known as a polled TXOP. Using the concept of TXOP as described above, a predetermined STA may be granted a predetermined time during which it is allowed to transmit frames, or its transmission time may be forcibly limited.

The transmission start time and maximum transmission duration of a TXOP are determined by the AP, and this information is notified to the STA through a beacon frame in the case of EDCA TXOP, and through a QoS CF-Poll frame in the case of a polled TXOP.

The NAV may be understood as a type of timer used to protect the TXOP of the transmitting STA (e.g., the TXOP holder). The STA may protect the TXOP of another STA by refraining from accessing the channel during a period when the NAV configured for the STA itself is valid. In current WLAN systems, a TXOP duration is configured through a duration field in the MAC header. That is, the TXOP holder and the TXOP responder (e.g., an Rx STA) include, in the duration field of frames that are transmitted and received between them, the full TXOP information required for transmission and reception of frames. Third-party STAs, which are neither the TXOP holder nor the TXOP responder, identify the duration field of frames exchanged between the TXOP holder and the TXOP responder and configure/update their NAVs, thereby deferring their own channel access until the NAV period ends.

The following describes the IEEE 802.11be standard. IEEE 802.11be, which is also referred to as extremely high throughput (EHT), operates in the 2.4, 5, and 6 GHz bands, and introduces features such as 320 MHz wide channel bandwidth, 4096 QAM, multi-resource unit allocation, and multi-link operation (MLO), thereby being developed to deliver speeds up to 46 Gbps, which is 4.8 times faster than Wi-Fi 6, while providing lower latency and higher network throughput. Specifically, 802.11be provides a 320 MHz wide bandwidth in the 6 GHz band and enables data transmission through MU-MIMO with up to 16 spatial streams in both uplink and downlink, and also adopts 4096 QAM to achieve higher transmission efficiency. In addition, 802.11be enhances spectral efficiency by enabling flexible scheduling of spectrum resources through the use of multiple Rus, and allows simultaneous data transmission and reception across various frequency bands and channels through multi-link operation.

The following describes overlapping basic service sets (OBSS). In conventional wireless LAN networks, performance such as the data transmission rate can significantly degrade as the number of users increases. This degradation occurs because wireless LAN systems basically use the CSMA/CA scheme corresponding to time-division access control. Accordingly, when a neighboring network is detected, the frequency resources of the same band are shared according to the activity time of the neighboring network.

Currently, it is common to have multiple APs operating in a specific area, and in this case, the performance of the wireless LAN network is degraded due to coverage overlap between APs. This is because the APs in each BSS and the STAs connected to the APs are affected by signals from neighboring BSSs and are therefore subject to interference from neighboring BSSs, resulting in reduced transmission rates due to collisions between signals transmitted at the same time. BSSs that may affect signal transmission (or have overlapping coverage) in this way may be referred to as overlapping BSSs (OBSS). To solve these problems, interference avoidance techniques are being studied, such as allocating non-overlapping bands to each user or performing channel switching to unused channels. In addition, interference alignment techniques are also being studied to mitigate the impact of interference even when the same frequency band is used.

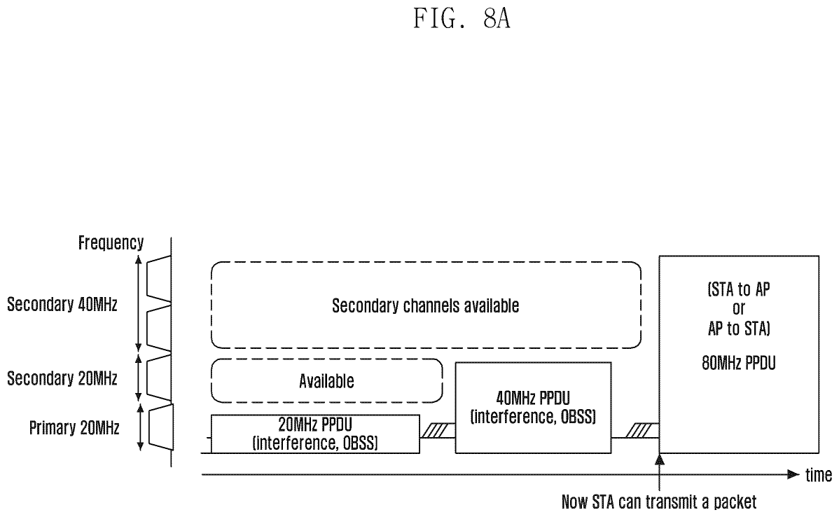

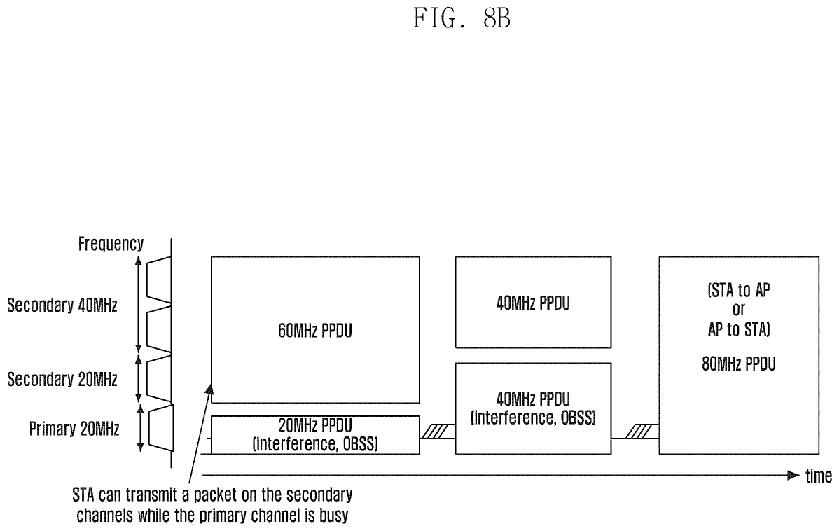

FIG. 8A illustrates an example of a channel access according to an embodiment of the disclosure, and FIG. 8B illustrates an example of a channel access according to an embodiment of the disclosure. FIGS. 8A and 8B are provided for the purpose of explaining non-primary channel access (NPCA). Referring to FIGS. 8A and 8B, a wideband channel is illustrated as being configured by a 20 MHz primary channel (i.e., a primary 20 MHz channel) and multiple 20 MHz secondary channels (i.e., secondary 20 MHz channels). This is merely for convenience of explanation, and the scope of the disclosure is not limited thereto.

The primary channel refers to a common channel operated by all STAs that are members of a BSS. For example, in a BSS with 20 MHz, 40 MHz, 80 MHz, 160 MHz, or 80+80 MHz bandwidth, the primary channel may be a primary 20 MHz channel.

The secondary channels refer to channels associated with the primary channel and are used to create a channel wider than the primary channel. For instance, in a BSS with 40 MHz, 80 MHz, 160 MHz, or 80+80 MHz bandwidth, the secondary channel may be a secondary 20 MHz channel.

According to the current IEEE 801.11 standard, for any transmission (e.g., a transmission through a 20/40/80/160/320 MHz channel), the primary channel (primary 20 MHz channel) should be idle to permit access to a wideband channel greater than 20 MHz. Therefore, if the primary channel is busy, the AP/STA is not allowed to transmit on any idle secondary channel. In other words, even if the secondary channel is idle, while the primary channel is busy, no transmission may occur on the corresponding secondary channel.

Referring to FIG. 8A, even when the secondary channels are available, no transmission can be made if the primary channel is busy.

For example, interference caused by a 20 MHz PPDU corresponding to an overlapping BSS (OBSS) may render the primary channel busy. In this case, even if secondary channels of 60 MHz are available, transmission may not occur.

For example, interference due to a 40 MHz PPDU corresponding to an OBSS may cause the primary channel to be busy, and thus, even if secondary channels of 40 MHz are available, transmission may not occur.

That is, under the current IEEE 801.11 standard, an STA is permitted to transmit packets when the primary channel is idle. In other words, when the primary channel is idle, the STA may perform transmission (e.g., 80 MHz PPDU transmission) using the primary and secondary channels. This applies not only to uplink (UL) transmission by the STA, but also to downlink transmission (DL) by the AP.

Accordingly, the current secondary channel access mechanism (or scheme) is inefficient for wideband channel (e.g., 160 MHz channel, 320 MHz channel) or a large bandwidth, and there is a need for an improved secondary channel access mechanism (or scheme) that can fully utilize the wideband channel.

As a solution to the above-described problem, non-primary channel access (NPCA) has been discussed. NPCA may be triggered based on an OBSS PPDU and/or an OBSS TXOP. According to NPCA, when the primary channel is busy but a secondary channel is available, the AP/STA may perform transmission through the available secondary channel.

An NPCA primary channel may be defined among the secondary channels (or within a secondary channel). The NPCA primary channel may refer to a channel on which channel access (e.g., EDCA) is performed while the primary channel is busy. In other words, the NPCA primary channel may refer to a channel within secondary channels used for channel access while the primary channel is busy. In an example, the NPCA primary channel may have a bandwidth of 20 MHz, although this is merely illustrative and does not limit the scope of the disclosure. The NPCA primary channel may also be referred to as an anchor channel, but the disclosure is not limited to any particular terminology.

Referring to FIG. 8B, when the primary channel is busy, transmission may be performed through available secondary channels.

For instance, when the primary channel is busy due to interference caused by a 20 MHz PPDU corresponding to an OBSS, the STA may transmit a packet (e.g., a 60 MHz PPDU) through the available secondary channels while the primary channel is busy. Channel access may be performed through an anchor channel within the secondary channels, thereby enabling packet transmission through the secondary channels when the anchor channel is idle. This is equally applicable to both UL transmission by the STA and DL transmission by the AP.

For example, when the primary channel is busy due to interference from a 40 MHz PPDU corresponding to an OBSS, the STA may transmit packets (e.g., a 40 MHz PPDU) on available secondary channels while the primary channel is busy. Channel access may be performed on the anchor channel within the secondary channels, and accordingly, packets may be transmitted in the secondary channels when the anchor channel is idle. This applies not only to UL transmission of the STA but also to DL transmission of the AP.

In the description of an embodiment of the disclosure, an NPCA AP may refer to an AP having the capability to perform NPCA (or an AP that performs or is able to perform operations related to NPCA), and an NPCA STA may refer to an STA associated with an NPCA AP and having the capability to perform NPCA (or an STA that performs or is able to perform operations related to NPCA). Unless otherwise explicitly stated, the terms AP, NPCA AP, STA, and NPCA STA may be used interchangeably in the disclosure. In particular, the terms NPCA AP and NPCA STA, as used in the following description, refer to APs and/or STAs having the capability to perform NPCA, and are not limited to APs or STAs that are actually performing NPCA at the moment of description.

When an OBSS initiates an OBSS TXOP, the NPCA AP and/or NPCA STA within the BSS may configure a basic NAV (BasicNAV, NAV) and perform NPCA. For example, the BasicNAV may be configured for the primary channel. When it is identified, e.g., through an RTS-CTS exchange, that the OBSS has initiated an OBSS TXOP, the NPCA AP and/or NPCA STA within the BSS may configure a BasicNAV and perform NPCA. Whether or not NPCA is performed may be identified based on a comparison between the OBSS TXOP and a specific duration threshold. For example, when the OBSS TXOP is shorter than (or equal to or shorter than) the specific duration threshold, NPCA may not be performed. Conversely, when the OBSS TXOP is longer than (or equal to or longer than) the specific duration threshold, NPCA may be performed. This is based on the consideration that, when the OBSS TXOP is relatively short, it may be more efficient to wait for the OBSS TXOP to end rather than performing NPCA-based operations.

The secondary channels on which NPCA operates, and an anchor channel (e.g., a 20 MHz anchor channel) within the secondary channels on which a channel access procedure (e.g., EDCA) is to be performed, may be pre-configured or pre-agreed between the NPCA AP and/or the NPCA STA within the BSS. Although the secondary channels on which NPCA operates may be referred to as non-primary channels (NPCHs), the disclosure is not limited to this specific terminology.

The operation of an NPCA AP may be as follows:

The NPCA AP may not perform NPCA on bands outside its operating bandwidth. That is, the NPCA may be performed within the operating bandwidth of the NPCA AP.

The NPCA AP may initiate NPCA if a secondary channel is idle during a PIFS interval immediately preceding the starting point of an OBSS TXOP.

When the NPCA AP includes a separate NAV timer, i.e., if a separate NPCH NAV timer is configured for the anchor channel, the NPCA AP may not initiate a TXOP within the NPCH when the NPCH NAV timer has a non-zero value. When the NPCA AP includes a separate NAV timer, i.e., if a separate NPCH NAV timer is configured for the anchor channel, the NPCA AP may initiate a TXOP within the NPCH when the NPCH NAV timer has a value of zero.

The NPCA AP may perform channel access (e.g., EDCA contention) on the anchor channel in which OBSS transmissions do not overlap, and the remaining channels in the NPCH (excluding the anchor channel) may be accessed based on energy detection (ED). For example, if the PIFS is idle immediately before the expiration of the backoff counter of the anchor channel, the remaining channels may be accessed.

The operation of an NPCA STA may be as follows:

The NPCA STA may switch its operating bandwidth in order to perform NPCA. Unlike an NPCA AP, which may not perform NPCA on bands outside its operating bandwidth, the NPCA STA may change its operating bandwidth to perform NPCA. For example, the NPCA STA may perform NPCA according to the instructions/configurations of the AP and/or by switching to a pre-defined or pre-agreed operating bandwidth.

The NPCA capability of the STA and/or the on/off state of the NPCA capability may be configured through prior information and/or message exchanges. The STA and the AP may exchange Probe Request and Probe Response, or Association Request and Association Response, to identify whether the NPCA can be performed, that is, to identify the NPCA capability. Thereafter, AP and STA capable of performing NPCA may exchange OBSS information (e.g., MAC addresses of OBSS APs and STAs, color information, etc.) visible in the vicinity (detected in the vicinity) in order to establish a list of OBSSs with which they do not have a hidden relationship, and may perform NPCA when transmissions due to the corresponding OBSS occur. When performing the NPCA, the anchor channel for performing EDCA and the NPCH which includes the anchor channel and can be used for data transmission may be established in advance through information exchange between the NPCA AP and the NPCA STA.

Unless otherwise specifically noted, in the description relating to an embodiment of the disclosure, the term “equal to or greater than” may be replaced with “greater than,” and vice versa. Unless otherwise specifically noted, in the description relating to an embodiment of the disclosure, the term “equal to or less than” may be replaced with “less than,” and vice versa.

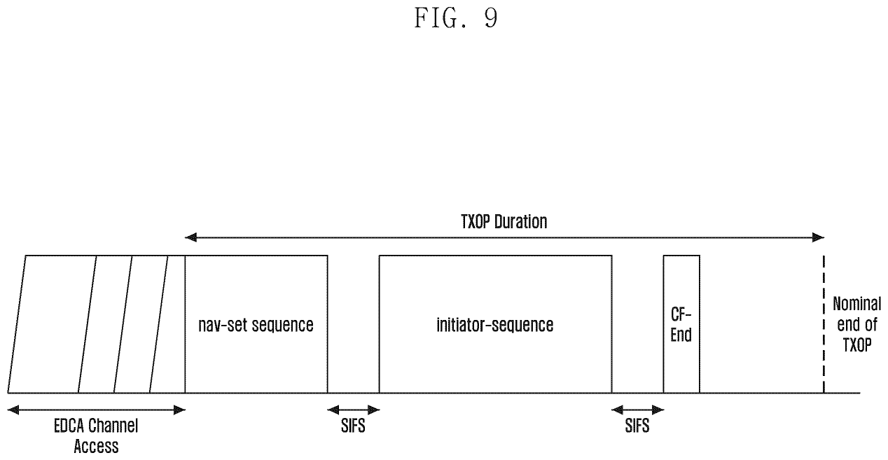

FIG. 9 illustrates an example of TXOP truncation according to an embodiment of the disclosure.

When an AP and/or STA that has acquired channel access via EDCA has emptied its transmission queue, if the length of the remaining duration is sufficiently long to allow transmission of a CF-End frame, the AP and/or STA may transmit the CF-End frame. By transmitting the CF-End frame, the AP and/or STA may explicitly indicate that its TXOP has ended. This is referred to as TXOP truncation.

Referring to FIG. 9, after accessing the medium using EDCA channel access, the AP and/or STA may transmit a sequence for NAV configuration (e.g., an RTS/CTS etc.). After SIFS, the TXOP holder and TXOP responder may transmit and receive PPDUs (e.g., an initiator sequence). When there is no more data to transmit within the TXOP limit, the TXOP holder may transmit a CF-End frame to truncate the TXOP. APs and/or STAs having received the CF-End frame may reset their NAV and begin contention for medium access without further delay.

Various embodiments of the disclosure provide operating methods of an NPCA AP and/or NPCA STA in the event of an OBSS TXOP truncation.

NPCA may be triggered based on an OBSS TXOP that includes the primary channel. When the primary channel is in a busy state due to the OBSS TXOP, the NPCA AP and/or NPCA STA may perform transmission and reception on available secondary channels. When the OBSS TXOP that triggered the NPCA is truncated, the NPCA AP and/or NPCA STA may attempt to acquire a TXOP by rejoining contention in the primary channel.

According to an embodiment, when an NPCA AP detects a CF-End in the primary channel, the NPCA AP may, based on the detection, identify that the OBSS TXOP including the primary channel has been truncated and immediately terminate NPCA, and then attempt to acquire a TXOP by participating in contention in the primary channel.

According to an embodiment, an NPCA STA having an operating bandwidth that includes the primary channel may detect a CF-End in the primary channel. Through this detection, the NPCA STA may identify that the OBSS TXOP including the primary channel has been truncated and immediately terminate NPCA, and then attempt to acquire a TXOP by participating in contention in the primary channel. Hereinafter, in the description of the disclosure, the NPCA STA having an operating bandwidth including the primary channel is referred to as a first NPCA STA or a first STA. These terms are used for illustrative purposes only and do not limit the scope of the disclosure.

According to an embodiment, an NPCA STA having an operating bandwidth that does not include a primary channel may not be able to detect the CF-End transmitted from the primary channel. Accordingly, the NPCA STA having an operating bandwidth that does not include a primary channel may not identify the truncation of the OBSS TXOP and may continue NPCA on the NPCH until NPCA is terminated. In the following description of the disclosure, an NPCA STA having an operating bandwidth that does not include a primary channel is referred to as a second NPCA STA or second STA. These designations are for illustrative purposes only and do not limit the scope of this disclosure.

The NPCA AP and/or NPCA STA that has identified the truncation of an OBSS TXOP may perform contention in the primary channel. Depending on the result of the contention: (1) the NPCA AP may fail to acquire a TXOP, thereby allowing the OBSS to reinitiate a TXOP; or (2) the NPCA AP may succeed in acquiring a TXOP, thereby initiating a TXOP by the NPCA AP.

Various embodiments of the disclosure provide operating methods of the NPCA AP and/or NPCA STA in the case of TXOP initiated by the OBSS, as described above in (1).

Various embodiments of the disclosure provide operating methods of the NPCA AP and/or NPCA STA in the case of TXOP initiated by the NPCA AP, as described above in (2).

Various embodiments of the disclosure provide a method for controlling NPCA by an STA that continues NPCA after an OBSS TXOP truncation, based on an NPCA termination control (NTC) frame.

In the following description, an OBSS TXOP in which TXOP truncation occurs is referred to as a first OBSS TXOP, an OBSS TXOP that is reinitiated after the TXOP truncation, depending on the result of contention in the primary channel, is referred to as a second OBSS TXOP, and a TXOP acquired by the NPCA AP after the TXOP truncation, depending on the result of contention in the primary channel, is referred to as an NPCA AP TXOP. Furthermore, in the following description, an OBSS that has initiated the first OBSS TXOP is referred to as a first OBSS, and the OBSS that has initiated the second OBSS TXOP is referred to as a second OBSS. Here, the second OBSS that has acquired the second OBSS TXOP may be a predetermined OBSS, and may be the same OBSS as the first OBSS that has acquired the first OBSS TXOP in which the TXOP truncation has occurred, or may be a different OBSS.

(1) Case in which OBSS TXOP is Initiated by OBSS

This case describes a situation in which an NPCA AP and/or NPCA STA perform contention in the primary channel but fails to acquire a TXOP, and the TXOP is initiated by an OBSS again.

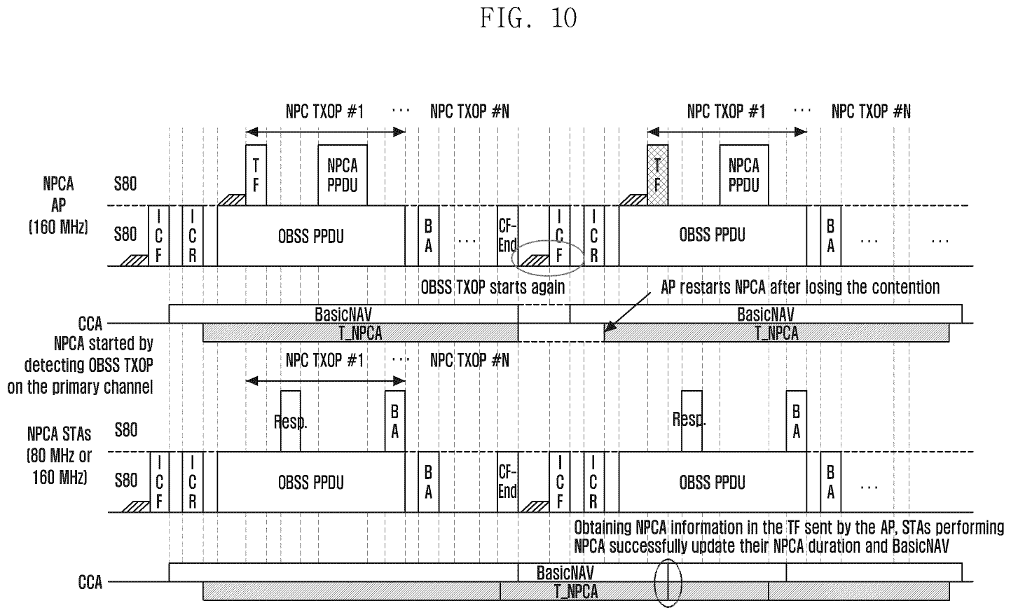

FIG. 10 illustrates an example of operations of an NPCA AP and/or NPCA STA when a second OBSS TXOP is initiated after the truncation of a first OBSS TXOP, according to an embodiment of the disclosure.

FIG. 10 exemplifies an operation in which the NPCA AP and/or NPCA STA operates within a total bandwidth of 160 MHz that includes a 80 MHz bandwidth channel (P80) including a primary channel and a 80 MHz bandwidth channel (S80) including secondary channels. However, this is merely illustrative purposes and does not limit the scope of the disclosure. Unless otherwise specifically noted hereinafter, in the disclosure, the 80 MHz bandwidth channel (P80) including a primary channel may be used interchangeably with the primary channel, and the 80 MHz bandwidth channel (S80) including secondary channels may be used interchangeably with the secondary channel or NPCH.

Referring to FIG. 10, a first OBSS may perform an OBSS initial control frame-initial control response (ICF-ICR) exchange in a bandwidth including the primary channel, and may transmit one or multiple OBSS PPDUs and one or multiple OBSS block ACKs (BAS) within the first OBSS TXOP.

The NPCA AP and/or NPCA STA may identify that the primary channel (P80) is busy due to the first OBSS TXOP, and if the secondary channel (S80) is available, may perform NPCA in the secondary channel (S80). For example, the NPCA AP may transmit a trigger frame (TF), and the NPCA STA may transmit a response thereto. The NPCA AP may transmit one or multiple NPCA PPDUs, and the NPCA STA may transmit block ACK (BA) information about the NPCA PPDUs.

The NPCA AP and/or NPCA STA may configure a BasicNAV and an NPCA duration (T_NPCA), based on detection of the first OBSS TXOP. For example, the BasicNAV related to the first OBSS TXOP may be configured based on the reception of the OBSS ICF for the first OBSS TXOP. The T_NPCA of NPCA triggered by the first OBSS TXOP may be configured after reception of the OBSS ICR for the first OBSS TXOP, or after reception of an OBSS PPDU, or after reception of a preamble of the OBSS PPDU.

When the first OBSS has no more data to transmit within the first OBSS TXOP, the first OBSS may truncate the first OBSS TXOP by transmitting a CF-End frame in the primary channel (P80). The NPCA AP and/or the first NPCA STA may detect the CF-End transmitted in the primary channel and thereby identify that the first OBSS TXOP has been truncated. In this case, the NPCA AP and/or the first NPCA STA may immediately reset the BasicNAV, terminate NPCA, and attempt contention in the primary channel (P80). On the other hand, the second NPCA STA may not be able to detect the CF-End transmitted in the primary channel (P80), and thus may continue NPCA in the secondary channel (S80).

After the truncation of the first OBSS TXOP, contention in the primary channel (P80) may result in the NPCA AP losing and the second OBSS winning, in which case, a second OBSS TXOP may be initiated. The second OBSS may perform an OBSS ICF-ICR exchange in a bandwidth including the primary channel and transmit one or multiple OBSS PPDUs and one or multiple OBSS BAs within the second OBSS TXOP.

Although the NPCA triggered by the first OBSS TXOP was performed under the assumption that the secondary channel (S80) was available, the second OBSS TXOP that is newly started may occupy only the primary channel (P80) or may occupy the entire bandwidth including the primary channel (P80) and the secondary channel (S80).

When the second OBSS TXOP occupies not only the primary channel (P80) but also the secondary channel (S80), such that the secondary channel (S80) becomes unavailable, then the NPCA AP and/or NPCA STA may not perform NPCA in the secondary channel (S80) during the second OBSS TXOP duration. In this case, the second NPCA STA may continue NPCA in the secondary channel (S80) without identifying the truncation of the first OBSS TXOP or the initiation of the second OBSS TXOP. However, while performing NPCA, if the second NPCA STA detects a DL MU PPDU including the primary channel (P80) in the secondary channel, the second NPCA STA may recognize that a TXOP occupying the secondary channel (S80) has started, and immediately terminate the ongoing NPCA.

When the secondary channel (S80) remains available even after initiation of the second OBSS TXOP, the NPCA AP and/or NPCA STA may perform NPCA in the secondary channel (S80), based on detection of the second OBSS TXOP in the primary channel (P80). For example, the NPCA AP may transmit a trigger frame (TF), and the NPCA STA may transmit a response thereto. The NPCA AP may transmit one or more NPCA PPDUs, and the NPCA STA may transmit block ACK (BA) information about the NPCA PPDUs.

The NPCA AP and/or the first NPCA STA may reconfigure the BasicNAV and NPCA duration (T_NPCA), based on detection of the second OBSS TXOP in the primary channel (P80), and may perform NPCA. For example, the BasicNAV related to the second OBSS TXOP may be configured based on the reception of the OBSS ICF for the second OBSS TXOP. The T_NPCA of NPCA triggered by the second OBSS TXOP may be configured after reception of the OBSS ICR for the second OBSS TXOP, after reception of the OBSS PPDU, or after reception of the preamble of the OBSS PPDU.

Meanwhile, since the second NPCA STA does not identify the truncation of the first OBSS TXOP or the initiation of the second OBSS TXOP, the second NPCA STA may continue performing the ongoing NPCA (triggered by the first OBSS TXOP) in the secondary channel (S80). Accordingly, the second NPCA STA may not be aware of information about the newly initiated second OBSS TXOP (e.g., BasicNAV related to the second OBSS TXOP) and/or information about the NPCA triggered by the second OBSS TXOP (e.g., NPCA duration T_NPCA). Therefore, the NPCA AP may provide the second NPCA STA with information about the second OBSS TXOP and/or information about the NPCA triggered by the second OBSS TXOP, thereby enabling the second NPCA STA to update its BasicNAV and/or NPCA duration.

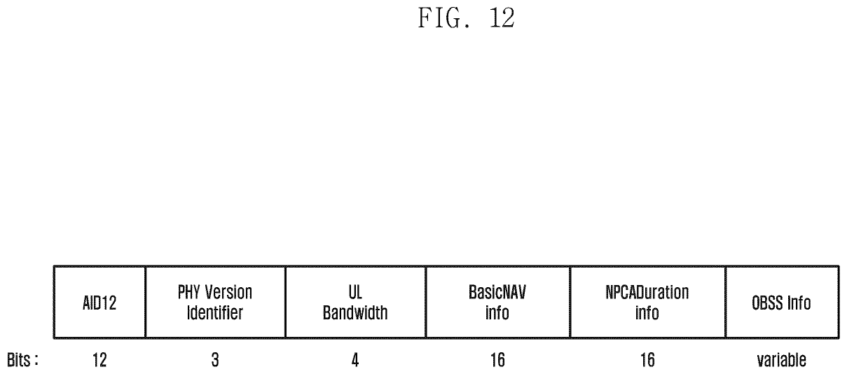

Hereinafter, a method for updating, by the NPCA AP and/or NPCA STA, information about the newly initiated second OBSS TXOP and/or information about the NPCA triggered by the second OBSS TXOP will be described. In the following description, the information about the second OBSS TXOP and/or information about the NPCA triggered by the second OBSS TXOP will be collectively referred to as “NPCA information”, and specific pieces of information that may be included in the NPCA information will be described later with reference to FIG. 12.

According to an embodiment, the NPCA AP may use a trigger frame (TF) transmitted at the start of NPCA, which is triggered by the second OBSS TXOP, to inform NPCA STAs of NPCA information. The trigger frame including the NPCA information may be transmitted in the secondary channel (S80), and the NPCA STA may obtain the NPCA information by receiving the trigger frame in the secondary channel (S80), and may update its BasicNAV and/or NPCA duration (T_NPCA) based on the obtained information.

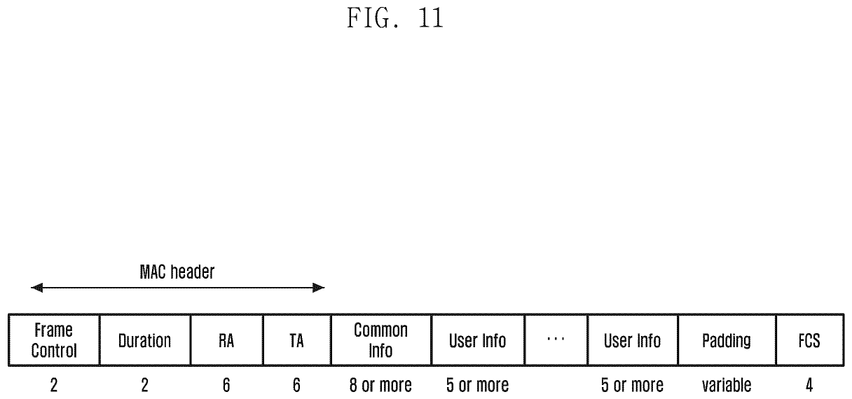

FIG. 11 illustrates an example of a trigger frame (TF) according to an embodiment of the disclosure.

Referring to FIG. 11, the trigger frame may include at least one of a frame control field, a duration field, a recipient STA address (RA) field, a transmitting STA address (TA) field, a common information field, one or more user information fields, and a frame check sum (FCS). The RA field indicates the address or ID of the recipient STA, and the TA field indicates the address of the transmitting STA.

The common information field may include at least one of a length subfield, a cascade indication, a HE-SIG A Info subfield, a CP/LTF type subfield, a trigger type subfield, and a trigger-dependent common information subfield. The length subfield indicates the L-SIG length of an uplink trigger-based (UL TB) PPDU. The cascade indication indicates whether the transmission of trigger frame following the current trigger frame occurs. The HE-SIG A Info subfield indicates content included in the HE-SIG A of the UL TB PPDU. The CP/LTF type subfield indicates the type of CP and HE LTF included in the UL TB PPDU. The trigger type subfield indicates the type of the trigger frame. The trigger frame may include type-specific common information and type-specific per-user information. Trigger Types may be configured as one of a basic trigger type (e.g., Type 0), beamforming report poll trigger type (e.g., Type 1), multi-user block ack request (MU-BAR) type (e.g., Type 2), and multi-user ready to send (MU-RTS) type (e.g., Type 3), but are not limited thereto. When the trigger type is MU-BAR, the trigger-dependent common information subfield may include a groupcast with retries (GCR) indication and a GCR address.

The user information field may include at least one of association ID (AID) subfield, a resource unit (RU) allocation subfield, a coding type subfield, a MCS subfield, a dual sub-carrier modulation (DCM) subfield, a spatial stream (SS) allocation subfield, and a trigger-dependent user Info subfield. The AID subfield indicates the AID of the STA that is to use the corresponding resource unit to transmit the MPDU of UL TB PPDU. The RU allocation subfield indicates a resource unit to be used by the STA to transmit the UL TB PPDU. The coding type subfield indicates the coding type of the UL TB PPDU transmitted by the STA. The MCS subfield indicates the MCS of the UL TB PPDU transmitted by the STA. The DCM subfield indicates information about dual sub-carrier modulation for the UL TB PPDU transmitted by the STA. The SS allocation subfield indicates information for a spatial stream of the UL TB PPDU transmitted by the STA. When the trigger type is MU-BAR, the trigger-dependent per-user information subfield may include BAR control and BAR information.

FIG. 12 illustrates an example of a user information field in a trigger frame for NPCA information transmission, according to an embodiment of the disclosure.

According to an embodiment, the NPCA AP may notify the NPCA STA of NPCA information by using at least one of the user information fields of the trigger frame. For example, at least one of the user information fields in the trigger frame may be used to notify of the NPCA information. In this case, the user information field for notifying of NPCA information may include at least one of the following subfields instead of the AID subfield, RU allocation subfield, coding type subfield, MCS field, DCM subfield, SS allocation subfield, and trigger-dependent user information subfield described with reference to FIG. 11 above.
AID Subfield: The AID subfield may include a specific value indicating that the user information field is used for NPCA information. For example, the specific value may be preconfigured by the NPCA AP for the NPCA STA, or defined as a specific value (e.g., 2006 etc.) and shared between the NPCA AP and/or NPCA STA. Alternatively, the specific value may be a value predefined in a standard. The NPCA AP may transmit NPCA information by configuring the AID subfield of the user information field to a specific value, and NPCA STA may identify that the user information field was used for NPCA information transmission when the received AID subfield of the user information field has a specific value.
BasicNAV Information Subfield: The BasicNAV information subfield may include a value indicating the remaining BasicNAV in the primary channel. For example, the BasicNAV information may indicate the remaining BasicNAV value of a second OBSS TXOP that includes the primary channel.
NPCA Duration Information Subfield: The NPCA duration information subfield may include a value indicating the length of the remaining NPCA duration. For example, the NPCA duration information subfield may indicate the length of the remaining NPCA duration with respect to an NPCA triggered by the second OBSS TXOP.
PHY Version Identifier (ID) Subfield: The PHY version identifier subfield may indicate the physical layer version of the requested TB PPDU, instead of an HE or HT TB PPDU. The PHY version identifier subfield may be configured as 1 for UHR, and values of 2 to 7 may be reserved.
UL Bandwidth Subfield: The UL bandwidth subfield may indicate the bandwidth of the requested TB PPDU including the anchor channel. The UL bandwidth subfield may include an encoded value or bitmap indicating the use of secondary channels.
OBSS Information Subfield: The OBSS information subfield may include information about the OBSS triggering NPCA. For example, the OBSS information subfield may include information about the second OBSS that occupies the second OBSS TXOP triggering the NPCA. The information about the OBSS may include, for example, the BSS color of the OBSS, the TA/RA MAC address, or the OBSS bandwidth.

The user information field for NPCA information may optionally include at least one of an AID subfield, a BasicNAV information subfield, an NPCA duration information subfield, a PHY version identifier subfield, a UL bandwidth subfield, and an OBSS information subfield. The user information field may also include at least one of an AID subfield, an RU allocation subfield, a coding type subfield, an MCS subfield, a DCM subfield, an SS allocation subfield, and a trigger-dependent user information subfield, which are included in the existing user information field.

According to an embodiment, when transmitting a trigger frame at the start of NPCA triggered by the second OBSS TXOP, the NPCA AP may configure at least one user information field of the trigger frame as a user information field for NPCA information, as described in the above embodiment, and transmit the trigger frame in the secondary channel (S80). The second NPCA STA may acquire the NPCA information by receiving the trigger frame including the user information field for NPCA information in the secondary channel (S80), and may update the BasicNAV and the NPCA duration (T_NPCA) based on the obtained information.

(2) Case in which TXOP is Initiated by NPCA AP

This case describes a situation in which the NPCA AP and/or NPCA STA performs contention in the primary channel, win the contention, and acquire a TXOP.

According to an embodiment, after the truncation of the first OBSS TXOP, the NPCA AP may win contention in the primary channel, resulting in the initiation of an NPCA AP TXOP. The NPCA AP TXOP may occupy both the primary channel and the secondary channel during its TXOP duration.

According to an embodiment, the NPCA AP and/or the first NPCA STA may identify the termination of the first OBSS TXOP by detecting a CF-End frame, and may immediately terminate the NPCA. Accordingly, upon initiation of the NPCA AP TXOP, the NPCA AP and/or the first NPCA STA perform transmission and reception through the primary and secondary channels, instead of performing NPCA within the TXOP duration.

According to an embodiment, since the second NPCA STA is unable to identify the truncation of the first OBSS TXOP based on CF-End detection, the second NPCA STA continues NPCA even if the first OBSS TXOP is truncated. Thereafter, even if the NPCA AP wins the contention and initiates an NPCA AP TXOP, the second NPCA STA, which has been performing NPCA in the secondary channel, may perform transmission and reception while continuing to perform NPCA in the secondary channel without switching its operating bandwidth to the primary channel.

The following describes a method for controlling NPCA by the second NPCA STA performing NPCA in the secondary channel after acquiring the NPCA AP TXOP.

According to an embodiment, the NPCA AP may initiate a TXOP along with the transmission of an ICF (e.g., an MU-RTS, a basic trigger frame, or an RTS). The ICF may be transmitted through the entire bandwidth including the primary and secondary channels, and the second NPCA STA may receive the ICF in the secondary channel. The ICF may be transmitted, based on a non-high throughput (non-HT) duplicate format, through the entire bandwidth including the primary and secondary channels. Here, the non-HT duplicate format refers to a transmission scheme in which an identical PPDU is duplicated in 20 MHz units and transmitted across the entire bandwidth. Accordingly, in the case of non-HT duplicate format-based transmission, a complete duplicated PPDU may be transmitted through the secondary channel, and the second NPCA STA may obtain meaningful information by receiving the ICF transmitted based on the non-HT duplicate format in the secondary channel.

According to an embodiment, in case that the ICF does not schedule the transmission of an ICR or a UL TB PPDU for the second NPCA STA, the second NPCA STA may start an NPCA termination timer. That is, even if the second NPCA STA receives the ICF but is not scheduled by the ICF, the second NPCA STA may start the NPCA termination timer upon receiving the ICF. According to an embodiment, if the ICF schedules the second NPCA STA to transmit or receive a PPDU within the NPCA AP TXOP, the second NPCA STA may reset the NPCA termination timer. The NPCA termination timer is used to control the termination of NPCA by the second NPCA STA. While the NPCA termination timer is running, the second NPCA STA may perform NPCA. When the NPCA termination timer expires, the second NPCA STA may terminate NPCA. The value of the NPCA termination timer may be pre-configured by the NPCA AP for the NPCA STA, or it may be defined as a specific value and shared between the NPCA AP and/or the NPCA STA. Alternatively, the value of the NPCA termination timer may be a value predefined by the standard. The value of the NPCA termination timer may also be defined or configured as zero. If the value of the NPCA termination timer is zero, the second NPCA STA may terminate NPCA immediately upon receiving an ICF that does not schedule the second NPCA STA.

While the NPCA termination timer is running, the second NPCA STA may perform NPCA. Upon expiration of the NPCA termination timer, the second NPCA STA may terminate NPCA.

According to an embodiment, when the ICF does not schedule the transmission of an ICR or UL TB PPDU for the second NPCA STA, the second NPCA STA may terminate NPCA. For example, the second NPCA STA may immediately terminate NPCA without using a separate NPCA termination timer, upon identifying that the received ICF does not schedule the transmission of the ICR or UL TB PPDU for the second NPCA STA.

According to an embodiment, when the ICF does not schedule the transmission of the ICR or UL TB PPDU for the second NPCA STA, whether the second NPCA STA (i) maintains or terminates NPCA based on an NPCA termination timer, or (ii) terminates NPCA immediately without using an NPCA termination timer, may be pre-configured by the NPCA AP for the NPCA STA, or may be defined in a specific manner and shared between the NPCA AP and/or the NPCA STA. Alternatively, the above operation may follow a method predefined in the standard. For example, the NPCA AP may configure the NPCA STA to use either method (i) or (ii). Such configuration may be performed explicitly or implicitly. As an example of explicit configuration, the NPCA AP may directly instruct the NPCA STA to use either method (i) or (ii). As an example of implicit configuration, the NPCA STA may recognize that, if a value of the NPCA termination timer is configured, method (i) is to be used, and if a value of the NPCA termination timer is not configured, method (ii) is to be used. Alternatively, the NPCA AP and/or NPCA STA may share the understanding that a specific one of the two methods, (i) or (ii), is to be used. Alternatively, whether the NPCA AP and/or NPCA STA use method (i) or method (ii) may be defined in the standard.

According to an embodiment, when the second NPCA STA performing NPCA receives a trigger frame requesting an ICR or UL TB PPDU, and More TF subfield in the common info field of the trigger frame has a value of 1, the STA may maintain NPCA during the TXOP period initiated by the AP. In this case, the NPCA termination timer may be reset or suspended.

According to an embodiment, the second NPCA STA performing NPCA may terminate NPCA before the end of the NPCA AP TXOP so as to maintain medium synchronization.

According to another embodiment, the NPCA AP that initiated the NPCA AP TXOP may transmit a DL MU PPDU to the second NPCA STA. The DL MU PPDU may be transmitted over the entire bandwidth including the primary and secondary channels, and the second NPCA STA may receive the DL MU PPDU in the secondary channel. The DL MU PPDU received by the second NPCA STA may or may not include an (A-)MPDU intended for the second NPCA STA.

When the DL MU PPDU received by the second NPCA STA does not include an (A-)MPDU for the second NPCA STA, the second NPCA STA may start an NPCA termination timer. The value of the NPCA termination timer may be pre-configured by the NPCA AP for the NPCA STA, or it may be defined as a specific value and shared between the NPCA AP and/or the NPCA STA. Alternatively, the value of the NPCA termination timer may be a value predefined in the standard. The value of the NPCA termination timer may also be defined or configured as zero. If the value of the NPCA termination timer is zero, and the DL MU PPDU received by the second NPCA STA does not include an (A-)MPDU for the second NPCA STA, the second NPCA STA may immediately terminate NPCA.

According to an embodiment, if the DL MU PPDU received by the second NPCA STA does not include an (A-)MPDU for the STA, the second NPCA STA may terminate NPCA. For example, without using a separate NPCA termination timer, the second NPCA STA may immediately terminate NPCA upon identifying that the received DL MU PPDU does not include an (A-)MPDU for the second NPCA STA.

According to an embodiment, when the DL MU PPDU received by the second NPCA STA does not include an (A-)MPDU intended for the second NPCA STA, (i) whether to maintain or terminate NPCA based on an NPCA termination timer or (ii) whether to immediately terminate NPCA without using an NPCA termination timer may be pre-configured by the NPCA AP for the NPCA STA, or may be defined as a specific method and shared between the NPCA AP and/or the NPCA STA. Alternatively, the above operation may follow a method predefined in the standard. For example, the NPCA AP may configure the NPCA STA to use one of the methods (i) or (ii). Such configuration may be performed either explicitly or implicitly. As an example of explicit configuration, the NPCA AP may directly indicate to the NPCA STA which of the two methods to use. As an example of implicit configuration, the NPCA STA may recognize that if a value of the NPCA termination timer is configured, method (i) is to be used, and if a value of the NPCA termination timer is not configured, method (ii) is to be used. Alternatively, the NPCA AP and/or NPCA STA may share the understanding that one of the two methods is to be used. Alternatively, whether the NPCA AP and/or NPCA STA use method (i) or method (ii) may be defined in the standard.

When, while the NPCA termination timer is running, the second NPCA STA receives a DL MU PPDU from the NPCA AP that includes an (A-)MPDU for the second NPCA STA, the second NPCA STA may reset the value of the NPCA termination timer. Thereafter, if a DL MU PPDU that does not contain an (A-)MPDU for the second NPCA STA is received, the second NPCA STA may restart the NPCA termination timer.

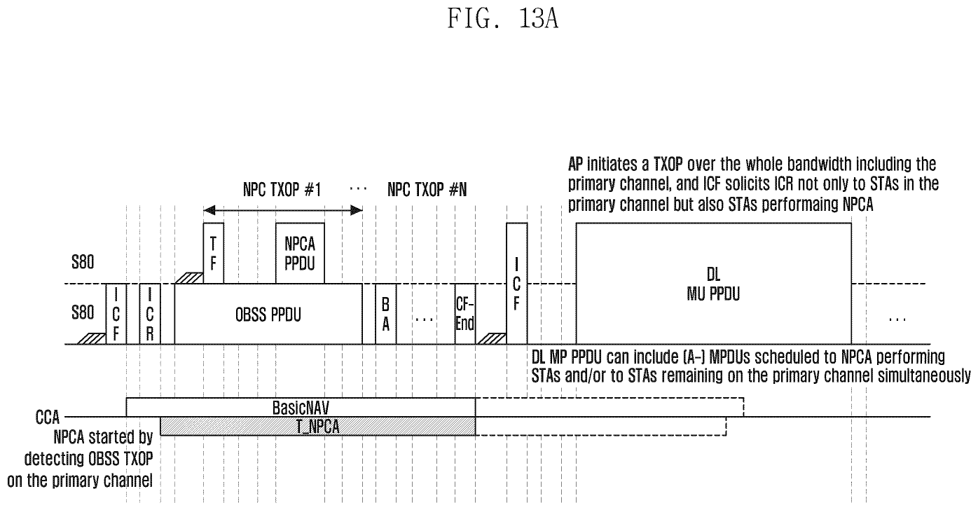

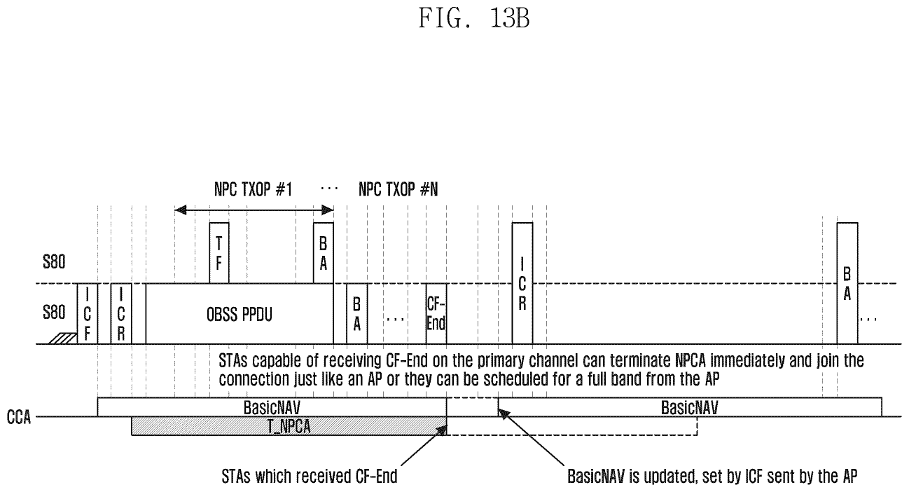

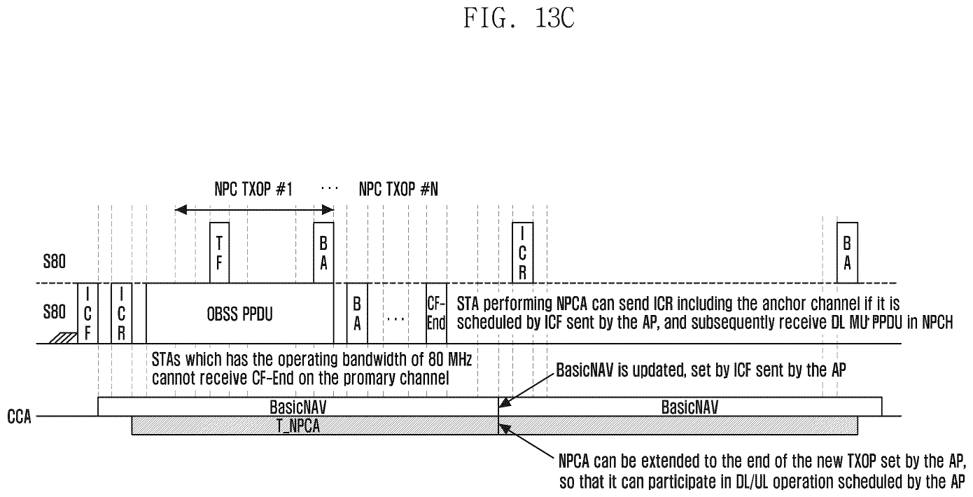

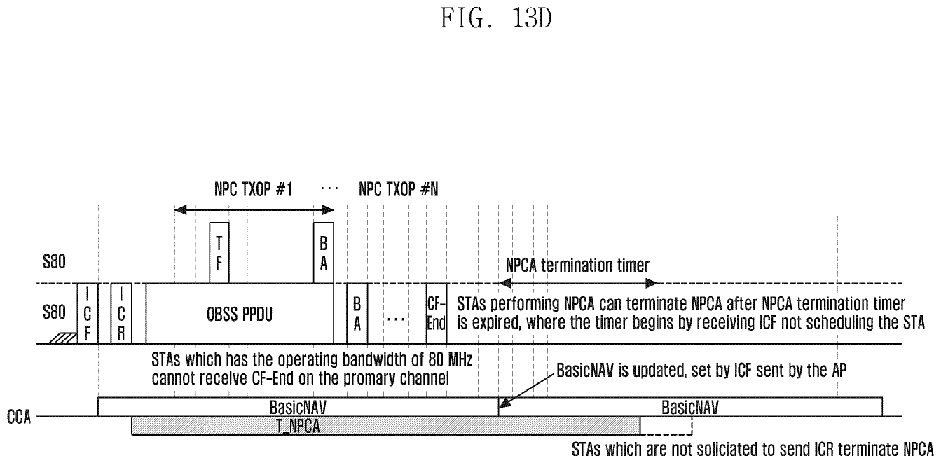

Hereinafter, with reference to FIGS. 13A to 13D, the operation of the NPCA AP and/or NPCA STA is described in detail in case that an NPCA AP TXOP is initiated after the truncation of a first OBSS TXOP.

FIGS. 13A to 13D exemplify an operation in which the NPCA AP and/or NPCA STA operates within a total bandwidth of 160 MHz that includes a 80 MHz bandwidth channel (P80) including a primary channel and a 80 MHz bandwidth channel (S80) including secondary channels. However, this is merely illustrative purposes and does not limit the scope of the disclosure. Unless otherwise specifically noted hereinafter, in the disclosure, the 80 MHz bandwidth channel (P80) including a primary channel may be used interchangeably with the primary channel, and the 80 MHz bandwidth channel (S80) including secondary channels may be used interchangeably with the secondary channel or NPCH.

FIG. 13A illustrates an example of the operation of an NPCA AP when an NPCA AP TXOP is initiated after the truncation of a first OBSS TXOP, according to an embodiment of the disclosure.

Referring to FIG. 13A, the first OBSS may perform an OBSS initial control frame-initial control response (ICF-ICR) exchange in a bandwidth including a primary channel, and may transmit one or multiple OBSS PPDUs and one or multiple OBSS block acknowledgments (BAS) within the first OBSS TXOP. When the first OBSS has no more data to transmit within the first OBSS TXOP, the first OBSS may truncate the first OBSS TXOP by transmitting a CF-End frame in the primary channel (P80).

Based on the detection of the first OBSS TXOP in the primary channel (P80), the NPCA AP may perform NPCA in the secondary channel (S80). For example, the NPCA AP may transmit a trigger frame (TF), and transmit one or more NPCA PPDUs.

The NPCA AP may configure a BasicNAV and an NPCA duration (T_NPCA) based on the detection of the first OBSS TXOP in the primary channel (P80). For instance, the BasicNAV associated with the first OBSS TXOP may be configured based on the reception of the OBSS ICF for the first OBSS TXOP. T_NPCA of the NPCA triggered by the first OBSS TXOP may be configured after the reception of the OBSS ICR for the first OBSS TXOP, after the reception of the OBSS PPDU, or after the reception of a preamble of the OBSS PPDU.

The NPCA AP may identify that the first OBSS TXOP has been truncated by detecting a CF-End transmitted in the primary channel (P80), and may immediately reset the BasicNAV, terminate the NPCA, and then participate in contention in the primary channel (P80).

After the truncation of the first OBSS TXOP, when the NPCA AP wins the contention in the primary channel (P80), the NPCA AP may initiate the NPCA AP TXOP over the entire bandwidth including the primary channel. At the start of the NPCA AP TXOP, the NPCA AP may transmit an ICF to the NPCA STA, and upon receiving an ICR from the NPCA STA, may then transmit one or multiple DL MU PPDUs to the NPCA STA within the NPCA AP TXOP. The NPCA AP may also receive BAs for the one or multiple DL MU PPDUs from the NPCA STA. The NPCA AP TXOP may occupy the entire bandwidth, including the primary channel (P80) and the secondary channel (S80). The ICF and/or NPCA DL PPDUs transmitted by the NPCA AP may be transmitted over the entire bandwidth and accordingly, the NPCA AP may request ICRs not only from a first NPCA STA having an operating bandwidth including the primary channel (P80), but also from a second NPCA STA having an operating bandwidth not including the primary channel.

FIG. 13B illustrates an example of the operation of an NPCA STA when an NPCA AP TXOP is initiated after the truncation of a first OBSS TXOP, according to an embodiment of the disclosure.

FIG. 13B shows the operation of a first NPCA STA having an operating bandwidth including a primary channel in case that an NPCA AP TXOP is initiated after the truncation of the first OBSS TXOP. The operation of the NPCA AP and/or NPCA STA triggered by the initiation of the first OBSS TXOP has been described above with reference to FIG. 13A, and detailed description thereof will be omitted.

Referring to FIG. 13B, the first NPCA STA may identify that the first OBSS TXOP has been truncated by detecting a CF-End transmitted in the primary channel (P80), and may immediately reset the BasicNAV, terminate the NPCA, and then participate in contention in the primary channel (P80).

According to an embodiment, after the truncation of the first OBSS TXOP, if the NPCA AP wins the contention in the primary channel (P80), the NPCA AP may initiate an NPCA AP TXOP over the entire bandwidth including the primary channel. The first NPCA STA may receive an ICF from the NPCA AP over the entire bandwidth including the primary channel. When the ICF schedules the first NPCA STA, the first NPCA STA may transmit an ICR to the NPCA AP, and then receive one or multiple DL MU PPDUs from the NPCA AP or transmit an UL TB PPDU within the NPCA AP TXOP. In addition, the first NPCA STA may transmit BAs for one or multiple DL MU PPDUs to the NPCA AP. When the ICF does not schedule the first NPCA STA, the first NPCA STA may configure a BasicNAV based on the ICF received from the NPCA AP.

FIG. 13C illustrates another example of the operation of an NPCA STA when an NPCA AP TXOP is initiated after the truncation of a first OBSS TXOP, according to an embodiment of the disclosure.

FIG. 13C shows the operation of a second NPCA STA, which is scheduled by an ICF, among second NPCA STAs having an operating bandwidth that does not include a primary channel when an NPCA AP TXOP is initiated after the truncation of the first OBSS TXOP. The operation of the NPCA AP and/or the NPCA STA triggered by the initiation of the first OBSS TXOP has been previously described with reference to FIG. 13A, and a detailed explanation thereof will be omitted.

Referring to FIG. 13C, the second NPCA STA is unable to detect the CF-End transmitted in the primary channel (P80), and therefore cannot identify that the first OBSS TXOP has been truncated. Accordingly, the second NPCA STA may continue performing NPCA in the secondary channel (S80) without terminating the NPCA.

According to an embodiment, the second NPCA STA may receive an ICF in the secondary channel (S80). The ICF may schedule the second NPCA STA. The second NPCA STA scheduled by the ICF may, as a response to the ICF, transmit an ICR in the secondary channel (S80). Thereafter, the second NPCA STA may receive a DL MU PPDU from the NPCA AP in the secondary channel (S80), and transmit a BA corresponding to the DL MU PPDU to the NPCA AP in the secondary channel (S80). In this case, the NPCA duration (T_NPCA) of the second NPCA STA may be extended until the end of the NPCA AP TXOP, thereby allowing the second NPCA STA to perform DL/UL operations scheduled by the NPCA AP through the secondary channel (S80) within the NPCA AP TXOP. The second NPCA STA may configure a BasicNAV based on the ICF received from the NPCA AP.

FIG. 13D illustrates another example of the operation of an NPCA STA when an NPCA AP TXOP is initiated after the truncation of a first OBSS TXOP, according to an embodiment of the disclosure.

FIG. 13D illustrates the operation of a second NPCA STA, which is not scheduled by an ICF, among second NPCA STAs having an operating bandwidth not including the primary channel when the NPCA AP TXOP is initiated after the truncation of the first OBSS TXOP. The operation of the NPCA AP and/or the NPCA STA triggered by the initiation of the first OBSS TXOP has been previously described with reference to FIG. 13A, and a detailed description thereof will be omitted.

Referring to FIG. 13D, the second NPCA STA may be unable to detect the CF-End transmitted in the primary channel (P80), and thus may not identify that the first OBSS TXOP has been truncated. Accordingly, the second NPCA STA may continue performing NPCA in the secondary channel (S80) without terminating the NPCA.

According to an embodiment, the second NPCA STA may receive an ICF in the secondary channel (S80). The ICF may not schedule the second NPCA STA. A second NPCA STA that is not scheduled by the ICF may start an NPCA termination timer upon receiving the ICF. The second NPCA STA may continue NPCA while the NPCA termination timer is running, and may terminate NPCA when the NPCA termination timer expires. In this case, the NPCA duration (T_NPCA) of the second NPCA STA may be configured to last until the NPCA termination timer expires. The second NPCA STA may configure a BasicNAV based on the ICF received from the NPCA AP.

Although FIG. 13D illustrates an example in which the second NPCA STA maintains or terminates NPCA based on an NPCA termination timer, this is merely one example and does not limit the scope of the disclosure. According to various embodiments described above, the second NPCA STA may terminate NPCA without using a separate NPCA termination timer. For example, when the second NPCA STA identifies that the received ICF does not schedule transmission of an ICR or an UL TB PPDU for the second NPCA STA, the second NPCA STA may immediately terminate the NPCA.

Hereinafter, an embodiment of the disclosure describes a method of explicitly instructing the second NPCA STA to terminate NPCA by using an NPCA termination control (NTC) frame.

According to an embodiment, an NPCA termination control (NTC) frame may be a frame used to instruct an NPCA STA whether to continue or terminate NPCA. When the NPCA AP identifies the truncation of an OBSS TXOP by detecting a CF-End, the NPCA AP may instruct the NPCA STA performing NPCA in the secondary channel to terminate the NPCA and return or switch its operating bandwidth to the primary channel based on the NTC frame. Since the NPCA STA performing NPCA in the secondary channel may not detect the CF-End in the primary channel and thus may be unable to identify the truncation of the OBSS TXOP, the NPCA STA may continue performing NPCA and then terminate NPCA based on the NTC frame, and return or switch its operating bandwidth to the primary channel.

According to an embodiment, the NTC frame may be transmitted over the entire bandwidth including the primary channel and the secondary channel. After identifying the truncation of the OBSS TXOP through CF-End detection, the NPCA AP may acquire a NPCA AP TXOP including the primary and secondary channels through contention. The NPCA AP may transmit the NTC frame over the entire bandwidth including the primary and secondary channels. After transmitting the NTC frame, the NPCA AP may transmit an ICF after a predetermined time (e.g., a SIFS).

According to another embodiment, the NPCA termination control (NTC) frame may be transmitted in the secondary channel.

According to an embodiment, the NTC frame may include information indicating, for each NPCA STA, whether to maintain or terminate NPCA. When transmitting the NTC frame, the NPCA AP may instruct some NPCA STAs to continue NPCA on the NPCH, while instructing other NPCA STAs to terminate NPCA and return to the primary channel. To this end, the NTC frame may include user information indicating whether each NPCA STA performing NPCA is to maintain NPCA or return to the primary channel. When the NTC frame instructs a NPCA STA to maintain NPCA, the NPCA STA may receive DL/UL scheduling via the secondary channel (NPCH) within the subsequent TXOP of the AP. When the NTC frame instructs a NPCA STA to return to the primary channel, the NPCA STA may terminate NPCA and change its operating bandwidth to the primary channel.

According to an embodiment, the information indicating, for each NPCA STA, whether to maintain or terminate NPCA may include a bitmap in which each bit is allocated to an individual NPCA STA. For example, a bit having a value of “0” in the bitmap may instruct the corresponding NPCA STA to maintain NPCA, and a bit having a value of “1” may instruct the corresponding NPCA STA to terminate NPCA and return to the primary channel. Alternatively, a bit having a value of “1” in the bitmap may instruct the corresponding NPCA STA to maintain NPCA, while a bit having a value of “0” in the bitmap may instruct the corresponding NPCA STA to terminate NPCA and return to the primary channel.

According to an embodiment, the information indicating, for each NPCA STA, whether to maintain or terminate NPCA may include fields allocated respectively to individual NPCA STAs. For example, each field allocated to an NPCA STA may include at least one of a subfield for identifying the NPCA STA corresponding to the field, and a subfield indicating whether the NPCA STA corresponding to the field is to maintain NPCA or to terminate NPCA and return to the primary channel.

According to an embodiment, the NTC frame may include information indicating whether to maintain or terminate NPCA for all NPCA STAs performing the NPCA. When the NTC frame indicates to maintain NPCA, all NPCA STAs performing NPCA may receive DL/UL scheduling through the secondary channel (NPCH) during the subsequent TXOP of the NPCA AP. When the NTC frame indicates to terminate NPCA, all NPCA STAs performing NPCA may terminate NPCA and return to the primary channel.

According to an embodiment, the NTC frame may include information regarding an NPCA maintenance time for the NPCA STA. The information regarding the NPCA maintenance time may indicate time information representing how long the NPCA STAs, which are instructed to maintain NPCA based on the information indicating, for each NPCA STA, whether to maintain or terminate NPCA and/or the information indicating whether to maintain or terminate NPCA for all NPCA STAs, are to perform the NPCA. For example, the NTC frame may include information on the NPCA maintenance time for each NPCA STA, and each NPCA STA instructed to maintain NPCA may perform NPCA based on the NPCA maintenance time information allocated to the NPCA STA itself. In another example, the NTC frame may include NPCA maintenance time information commonly applied to NPCA STAs that are instructed to maintain NPCA, and the NPCA STAs that are instructed to maintain NPCA may perform NPCA, based on the commonly applied NPCA maintenance time. An NPCA STA instructed to maintain NPCA may terminate NPCA without additional instruction after maintaining NPCA for a time indicated by the NPCA maintenance time information. The NPCA maintenance time information may be included together with information indicating, for each NPCA STA, whether to maintain or terminate NPCA and/or for all NPCA STAs, or may be included as separate information in the NTC frame.

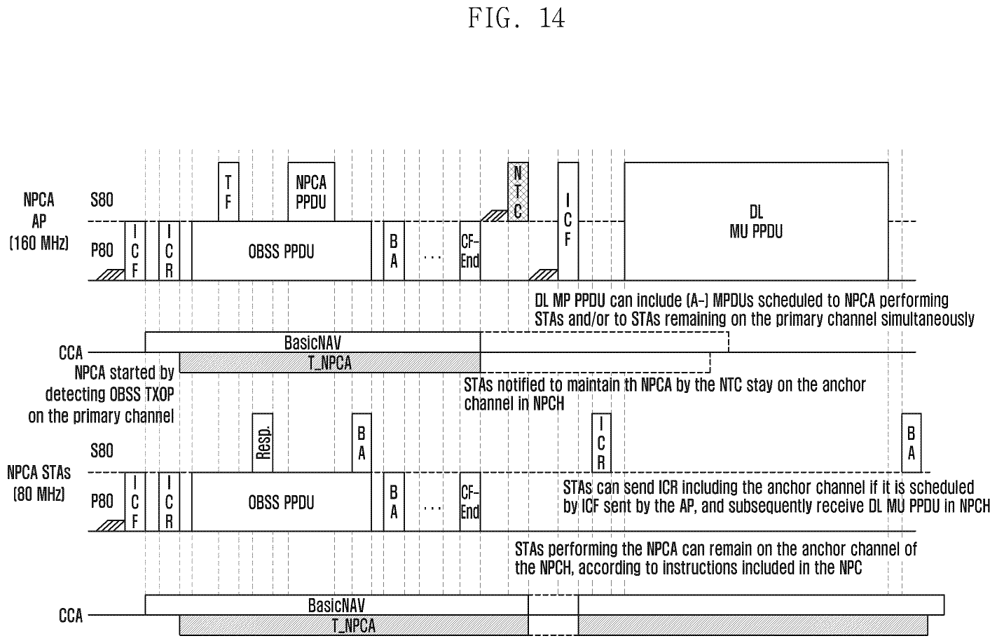

FIG. 14 illustrates an example of the operation of an NPCA AP and/or NPCA STA based on an NPCA termination control (NTC) frame, according to an embodiment of the disclosure.

Referring to FIG. 14, a first OBSS may perform an OBSS ICF-ICR exchange in a bandwidth including a primary channel, and may transmit one or multiple OBSS PPDUs and one or multiple OBSS BAs within the first OBSS TXOP.

The NPCA AP and/or NPCA STA may identify that the primary channel (P80) is busy by the first OBSS TXOP and may perform NPCA in the secondary channel (S80) when the secondary channel is available. For example, the NPCA AP may transmit a trigger frame (TF), and the NPCA STA may transmit a response thereto. The NPCA AP may transmit one or multiple NPCA PPDUs, and the NPCA STA may transmit block ACK (BA) information about the NPCA PPDUs.

The NPCA AP and/or NPCA STA may configure a BasicNAV and an NPCA duration (T_NPCA) based on detection of the first OBSS TXOP. For example, the BasicNAV related to the first OBSS TXOP may be configured based on reception of the OBSS ICF for the first OBSS TXOP. The T_NPCA of NPCA triggered by the first OBSS TXOP may be configured after reception of the OBSS ICR for the first OBSS TXOP, after reception of the OBSS PPDU, or after reception of the preamble of the OBSS PPDU.

When the first OBSS has no more data to transmit within the first OBSS TXOP, the first OBSS may truncate the first OBSS TXOP by transmitting a CF-End frame in the primary channel (P80). The NPCA AP and/or first NPCA STA may identify that the first OBSS TXOP has been truncated by detecting a CF-End transmitted in the primary channel (P80), and may immediately reset the BasicNAV, terminate the NPCA, and then participate in contention in the primary channel (P80). On the other hand, since the second NPCA STA is unable to detect the CF-End transmitted in the primary channel (P80), second NPCA STA may continue NPCA in the secondary channel (S80).

The NPCA AP may transmit an NTC frame in the secondary channel on which the second NPCA STA is performing NPCA. The NTC frame may include information indicating, for each NPCA STA, whether to maintain or terminate NPCA. When transmitting the NTC frame, the NPCA AP may instruct some NPCA STAs to continue NPCA on the NPCH, and other NPCA STAs to terminate NPCA and return to the primary channel.

According to an embodiment, an NPCA STA instructed to maintain NPCA through the NTC frame may continue performing NPCA while remain in the secondary channel (e.g., anchor channel of the NPCH). The NPCA STA may be scheduled through the secondary channel within the TXOP of the AP and perform DL/UL operations as scheduled by the NPCA AP.

According to another embodiment, an NPCA STA instructed via the NTC frame to terminate NPCA or return to the primary channel may terminate NPCA and change its operating bandwidth to the primary channel. The NPCA STA may be scheduled through the primary channel within the TXOP of the AP and perform DL/UL operations as scheduled by the NPCA AP.

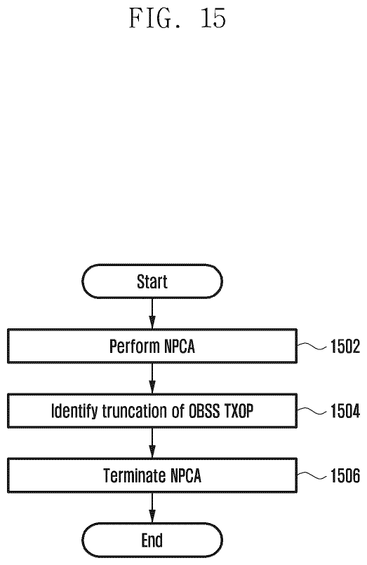

The operations of an AP and/or STA according to various embodiments of the disclosure will be described below with reference to FIGS. 15 to 17. The flowcharts of FIGS. 15 to 17 illustrate methods that may be implemented in accordance with the principles of the disclosure and are not intended to limit the scope of the disclosure. Various modifications may be made to the methods illustrated in the flowcharts. For example, although illustrated as a series of operations, the various operations in each figure may overlap, occur in parallel, occur in a different order, or be repeated multiple times. In other examples, an operation may be omitted or replaced with another operation. Furthermore, the AP and/or STA may perform operations for implementing various embodiments of the disclosure that are not illustrated in FIGS. 15 to 17 but are described in the above.

FIG. 15 illustrates an example of a method performed by an access point (AP) according to an embodiment of the disclosure.

Referring to FIG. 15, in operation 1502 according to an embodiment of the disclosure, the AP may perform NPCA triggered based on a first OBSS TXOP that includes a primary channel.

In operation 1504 according to an embodiment of the disclosure, the AP may identify truncation of the first OBSS TXOP, based on a CF-End frame detected in the primary channel.

In operation 1506 according to an embodiment of the disclosure, the AP may terminate the NPCA, based on the identification of the truncation of the first OBSS TXOP.

The AP that performs operations shown in FIG. 15 may be an NPCA AP performing various embodiments of the disclosure described above. Accordingly, more specific operations performed by the AP may refer to the various embodiments described above, and even if such operations are not shown in FIG. 15, the AP may perform operations necessary to implement the various embodiments of the disclosure.

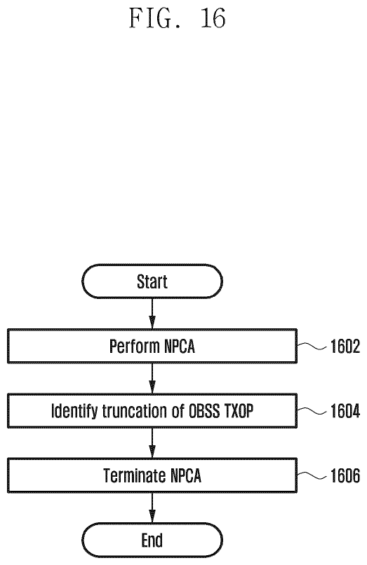

FIG. 16 illustrates an example of a method performed by a first station (STA), according to an embodiment of the disclosure.

Referring to FIG. 16, in operation 1602 according to an embodiment of the disclosure, the first STA may perform NPCA triggered based on a first OBSS TXOP that includes a primary channel.

In operation 1604 according to an embodiment of the disclosure, the first STA may identify truncation of the first OBSS TXOP, based on a CF-End frame detected in the primary channel.

In operation 1606 according to an embodiment of the disclosure, the first STA may terminate the NPCA, based on the identification of the truncation of the first OBSS TXOP.

The first STA that performs operations shown in FIG. 16 may be a first NPCA STA performing various embodiments of the disclosure described above. Accordingly, more specific operations performed by the first STA may refer to the various embodiments described above, and even if such operations are not shown in FIG. 16, the first STA may perform operations necessary to implement the various embodiments of the disclosure.

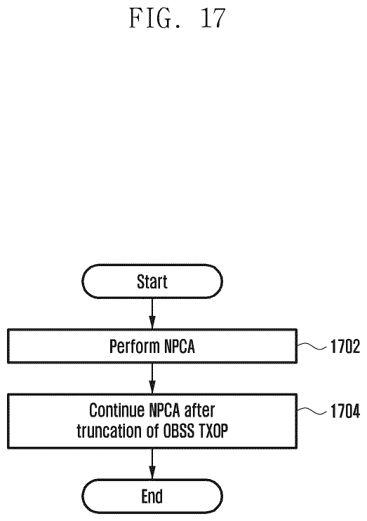

FIG. 17 illustrates an example of a method performed by a second station (STA), according to an embodiment of the disclosure.

Referring to FIG. 17, in operation 1702 according to an embodiment of the disclosure, the second STA may perform NPCA triggered based on a first OBSS TXOP that includes a primary channel.

In operation 1704 according to an embodiment of the disclosure, the second STA may continue NPCA even after the truncation of the first OBSS TXOP.

The second STA that performs operations shown in FIG. 17 may be a second NPCA STA performing various embodiments of the disclosure described above. Accordingly, more specific operations performed by the second STA may refer to the various embodiments described above, and even if such operations are not shown in FIG. 17, the second STA may perform operations necessary to implement the various embodiments of the disclosure.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wireless LAN (WLAN), and Storage Area Network (SAN) or a combination thereof. Such a storage device may access the electronic device via an external port. Also, a separate storage device on the communication network may access a portable electronic device.

In the above-described specific embodiments of the disclosure, an element included in an embodiment is expressed in the singular or the plural according to presented specific embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an access point (AP) in a wireless local area network (WLAN) system, the method comprising:
identifying, by the AP, a first overlapping basic service set (OBSS) transmission opportunity (TXOP) including a primary channel;
performing, by the AP, non-primary channel access (NPCA) based on identifying the first OBSS TXOP;
identifying, by the AP, truncation of the first OBSS TXOP; and
terminating, by the AP, the NPCA based on identifying the truncation of the first OBSS TXOP.

2. The method of claim 1, further comprising:
identifying a second OBSS TXOP after the truncation of the first OBSS TXOP; and
performing NPCA based on identifying the second OBSS TXOP.

3. The method of claim 1,
wherein a trigger frame (TF) related to the NPCA comprises a user information field containing NPCA information,
wherein the user information field comprises at least one of:
a BasicNAV information subfield indicating a BasicNAV value associated with a OBSS TXOP including the primary channel, or
an NPCA duration subfield indicating a remaining NPCA duration, and
wherein an association ID (AID) subfield of the user information field containing NPCA information has a predetermined value.

4. The method of claim 1, further comprising, in case that an AP TXOP is initiated after the truncation of the first OBSS TXOP:
transmitting an initial control frame (ICF) for the AP TXOP in the primary channel and a secondary channel;
receiving an initial control response (ICR) in the primary channel and the secondary channel from a first station (STA) having an operating bandwidth including the primary channel; and
in case that the ICF schedules a second STA having an operating bandwidth not including the primary channel, receiving the ICR in the secondary channel from the second STA.

5. The method of claim 1, further comprising, in case that an AP TXOP is initiated after the truncation of the first OBSS TXOP, transmitting a downlink (DL) multi-user (MU) physical layer protocol data unit (PPDU) in the primary channel and the secondary channel within the AP TXOP.

6. The method of claim 1, further comprising transmitting an NPCA termination control (NTC) frame,
wherein the NTC frame comprises information indicating whether to maintain or terminate the NPCA by the second STA.

7. A method performed by a first station (STA) in a wireless local area network (WLAN) system, the method comprising:
identifying, by the first STA, a first overlapping basic service set (OBSS) transmission opportunity (TXOP) including a primary channel;
performing, by the first STA, non-primary channel access (NPCA) based on identifying the first OBSS TXOP;
identifying, by the first STA, truncation of the first OBSS TXOP based on the first STA having an operating bandwidth including the primary channel; and
terminating, by the first STA, the NPCA based on identifying the truncation of the first OBSS TXOP.

8. The method of claim 7, further comprising:
identifying a second OBSS TXOP after the truncation of the first OBSS TXOP; and
performing NPCA based on identifying the second OBSS TXOP.

9. The method of claim 7, further comprising, in case that an AP TXOP is initiated after the truncation of the first OBSS TXOP:
receiving an initial control frame (ICF) for the AP TXOP in a primary channel and a secondary channel; and
transmitting an initial control response (ICR) in the primary channel and the secondary channel.

10. A method performed by a second station (STA) in a wireless local area network (WLAN) system, the method comprising:
performing, by the second STA, non-primary channel access (NPCA) triggered based on a first overlapping basic service set (OBSS) transmission opportunity (TXOP) including a primary channel; and
continuing, by the second STA, the NPCA after truncation of the first OBSS TXOP based on the second STA having an operating bandwidth not including the primary channel.

11. The method of claim 10, further comprising, based on receiving a downlink (DL) multi-user (MU) physical layer protocol data unit (PPDU) including the primary channel, terminating the NPCA.

12. The method of claim 10,
wherein a trigger frame (TF) related to NPCA comprises a user information field containing NPCA information,
wherein the user information field comprises at least one of:
a BasicNAV information subfield indicating a BasicNAV value associated with a OBSS TXOP including the primary channel, or
an NPCA duration subfield indicating a remaining NPCA duration, and
wherein an association ID (AID) subfield of the user information field containing NPCA information has a predetermined value.

13. The method of claim 12, further comprising:
receiving the TF related to NPCA triggered by a second OBSS TXOP, in case that the second OBSS TXOP is initiated after the truncation of the first OBSS TXOP;
configuring a BasicNAV value associated with the second OBSS TXOP based on the BasicNAV information subfield; and
configuring a duration of the NPCA triggered by the second OBSS TXOP based on the NPCA duration subfield.

14. The method of claim 10, further comprising, in case that an AP TXOP is initiated after the truncation of the first OBSS TXOP:
receiving an initial control frame (ICF) for the AP TXOP in a secondary channel;
in case that the ICF schedules the second STA having an operating bandwidth not including the primary channel, transmitting an initial control response (ICR) in the secondary channel; and
in case that the ICF does not schedule the second STA, starting an NPCA termination timer of the second STA.

15. The method of claim 10, further comprising, in case that an AP TXOP is initiated after the truncation of the first OBSS TXOP:
receiving an initial control frame (ICF) for the AP TXOP in a secondary channel;
in case that the ICF schedules the second STA having an operating bandwidth not including the primary channel, transmitting an initial control response (ICR) in the secondary channel; and
in case that the ICF does not schedule the second STA, terminating the NPCA.

16. The method of claim 10, further comprising, in case that the AP TXOP is initiated after the truncation of the first OBSS TXOP, receiving a downlink (DL) multi-user (MU) physical layer protocol data unit (PPDU) within the AP TXOP,
wherein, in case that the DL MU PPDU comprises a medium access control (MAC) protocol data unit (MPDU) for the second STA, an NPCA termination timer of the second STA is reset, and
wherein, in case that the DL MU PPDU does not include the MPDU for the second STA, the NPCA termination timer of the second STA is started.

17. The method of claim 10, further comprising receiving an NPCA termination control (NTC) frame in a secondary channel,
wherein the NTC frame comprises information indicating whether to maintain or terminate the NPCA by the second STA,
wherein, in case that the NTC frame indicates to maintain the NPCA by the second STA, the second STA continues the NPCA in the secondary channel, and
wherein, in case that the NTC frame indicates to terminate the NPCA by the second STA, the second STA terminates the NPCA.

18. An access point (AP) in a wireless local area network (WLAN) system, the AP comprising:
a transceiver;
memory, comprising one or more storage media, storing instructions; and
one or more processors communicatively coupled to the transceiver and the memory,
wherein the instructions, when executed by the one or more processors individually or collectively, cause the AP to:
identify a first overlapping basic service set (OBSS) transmission opportunity (TXOP) including a primary channel,
perform non-primary channel access (NPCA) based on identifying the first OBSS TXOP,
identify truncation of the first OBSS TXOP, and
terminate the NPCA based on identifying the truncation of the first OBSS TXOP.

19. A first station (STA) in a wireless local area network (WLAN) system, the first STA comprising:
a transceiver;
memory, comprising one or more storage media, storing instructions; and
one or more processors communicatively coupled to the transceiver and the memory,
wherein the instructions, when executed by the one or more processors individually or collectively, cause the first STA to:
identify a first overlapping basic service set (OBSS) transmission opportunity (TXOP) including a primary channel,
perform non-primary channel access (NPCA) based on identifying the first OBSS TXOP,
identify truncation of the first OBSS TXOP based on the first STA having an operating bandwidth including the primary channel, and
terminate the NPCA based on identifying the truncation of the first OBSS TXOP.

20. A second station (STA) in a wireless local area network (WLAN) system, the second STA comprising:
a transceiver;
memory, comprising one or more storage media, storing instructions; and
one or more processors communicatively coupled to the transceiver and the memory,
wherein the instructions, when executed by the one or more processors individually or collectively, cause the second STA to:
perform non-primary channel access (NPCA) triggered based on a first overlapping basic service set (OBSS) transmission opportunity (TXOP) including a primary channel, and
continue the NPCA after truncation of the first OBSS TXOP based on the second STA having an operating bandwidth not including the primary channel.
